(19) United States
(12) Patent Application Publication
(10) Pub. No.: US 2026/0202998 A1
(43) Pub. Date: Jul. 16, 2026

(54) INFORMATION PROCESSING APPARATUS, METHOD FOR CONTROLLING INFORMATION PROCESSING APPARATUS, AND STORAGE MEDIUM

(71) Applicant: CANON KABUSHIKI KAISHA, Tokyo (JP)

(72) Inventor: SHUKEI KURIHARA, Kanagawa (JP)

(21) Appl. No.: 19/443,193

(22) Filed: Jan. 8, 2026

(30) Foreign Application Priority Data
Jan. 15, 2025 (JP) 2025-005469

(51) Int. Cl. G06F 3/12

(52) U.S. Cl. CPC G06F 3/1204; G06F 3/1255; G06F 3/1288

(57) ABSTRACT

A method for controlling an information processing apparatus executing a first application program includes: executing first processing which is processing for gaining, from a user, consent to transmission of predetermined information for using a predetermined service; on a basis that the consent to transmission of the predetermined information is gained from the user as a result of the execution of the first processing, transmitting information indicating that the consent to transmission of the predetermined information has been gained to a communication apparatus; obtaining the predetermined information from the communication apparatus; and after the consent to transmission of the predetermined information is gained from the user as a result of the execution of the first processing, executing second processing which is processing for displaying the predetermined information.

### BACKGROUND

### Field of the Technology

The present disclosure relates to an information processing apparatus, a method for controlling the information processing apparatus, and a storage medium.

### Description of the Related Art

A system is known where printing is executed from an information processing apparatus, such as a personal computer (PC) or a mobile terminal, via a cloud-based server. Specifically, an information processing apparatus issues a print request to a cloud print service server built on the cloud, and the cloud print service server transmits the print request to the printing apparatus associated on the cloud print service server.

In Literature 1 (Japanese Patent Laid-Open No. 2023-122867) discloses a configuration for registering information for identifying a printing apparatus with a data conversion service.

Because the form of using a predetermined service through an application program is becoming widespread, improvement in the convenience of such form is demanded.

### SUMMARY

A method for controlling an information processing apparatus according to an aspect of the present disclosure is a method for controlling an information processing apparatus executing a first application program, the method including: executing first processing which is processing for gaining, from a user, consent to transmission of predetermined information for using a predetermined service; on a basis that the consent to transmission of the predetermined information is gained from the user as a result of the execution of the first processing, transmitting, to a communication apparatus, information indicating that the consent to transmission of the predetermined information was gained; obtaining the predetermined information from the communication apparatus; and after the consent to transmission of the predetermined information is gained from the user as a result of the execution of the first processing, executing second processing which is processing for displaying the predetermined information. On a basis that the information indicating that the consent to transmission of the predetermined information had been gained is transmitted to the communication apparatus, the predetermined information and information on the communication apparatus are transmitted to a server external to the communication apparatus. By receiving input of the predetermined information, a second application program obtains the information on the communication apparatus from a server external to the information processing apparatus, the second application program being an application program different from the first application program and an application program for using the predetermined service.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example configuration of an information processing system;

FIG. 2 is a block diagram showing a hardware configuration of a mobile terminal;

FIG. 3 is a block diagram showing a hardware configuration of a printing apparatus;

FIG. 4 is a block diagram showing a software configuration of the mobile terminal;

FIG. 5 is a block diagram showing a software configuration of the printing apparatus;

FIG. 6 is a diagram showing the relationship of FIGS. 6A and 6B;

FIGS. 6A and 6B are totally a diagram showing a flowchart showing example processing performed by the mobile terminal;

FIG. 7 is a diagram showing a flowchart showing example processing performed by the mobile terminal;

FIGS. 8A to 8D are diagrams showing example screens displayed on the mobile terminal;

FIGS. 9A to 9D are diagrams showing example screens displayed on the mobile terminal;

FIGS. 10A to 10C are diagrams showing example screens displayed on the mobile terminal;

FIG. 11 is a diagram showing an example screen displayed on the mobile terminal;

FIG. 12 shows a diagram according to a comparative example with room for improvement in usability;

FIG. 13 is a diagram illustrating an overview of an embodiment; and

FIG. 14 is a diagram illustrating an overview of the embodiment.

### DESCRIPTION OF THE EMBODIMENTS

Preferred embodiments of the present disclosure are described in detail below with reference to the drawings attached hereto. Note that the embodiments below are not to limit the matters of the present disclosure, and not all the combinations of features described in the embodiments below are necessarily essential to solutions provided by the present disclosure. Note that the same constituents are denoted by the same reference numeral.

### First Embodiment

### Overview

The present embodiment describes the form of using an application program (hereinafter referred to simply as an application or app) used on a mobile terminal such as a smartphone or a tablet terminal. In the present embodiment, there are roughly two apps. A first one of the apps (referred to as a first app or a first application) is a print app. A print app is, for example, an app that can perform initial setup, such as configuring network settings, for a newly purchased printer and allow a print instruction to be outputted to the printer through the print app. The print app is also used in registering the printer with a cloud print service. A second one of the apps (referred to as a second app or a second application) is a social networking service (SNS) app.

The embodiment below describes an example of improving usability in preparation for performing cloud printing with the second app by performing predetermined processing on the first app. In the main scenario assumed here, a user who has purchased a new printer performs various operations so as to use the printer with the second app. Note, however, that this is merely an example and the present disclosure is not limited to this.

Before discussing the embodiment, the background is supplementarily described. An app called WeChat (registered trademark) is known as one of SNS apps. WeChat is a multifunctional app providing services such as a chat service and a social media mobile payment service. By using WeChat, a user can enjoy chatting with a friend, reading news, and shopping online all within a single app, WeChat. Further, with an app of this type, by registering a program called mini app into WeChat, the user can use various services using the mini app. An app for printing is provided as one of mini apps (hereinafter referred to as a mini app for printing), and a user can execute printing using the mini app for printing within WeChat.

Because a mini app for printing is not permitted to perform printing by directly connecting to the printer, a cloud printing service needs to be used for printing using a mini app for printing. To use a cloud print service, the target printer needs to be registered with the cloud print service. To register the target printer with the cloud print service, it is necessary from the perspective of personal information protection to gain consent from the user about transmission of information necessary for using the service. Gaining the consent is performed not on the second app like WeChat, but on the first app (print app) communicating with the target printer.

After the consent is gained from the user on the first app, the target printer is registered with the cloud print service. In this event, identification information (such as a serial number) identifying the target printer is registered with the cloud print service. More specifically, after the consent is gained on the first app, the first app notifies the target printer that the consent has been gained, and the printer notifies the cloud print service that the consent has been gained. In this event, the printer notifies the cloud print service of its own serial number. The target printer is thereby registered with the cloud print service. After the target printer is registered with the cloud print service, the user on the second app (WeChat) activates the mini app for printing within the second app and enters identification information (serial number) on the registered printer. In response to the entering, the mini app for printing verifies the identification information with the cloud print service, and in a case where there is no problem, the target printer is registered with the mini app for printing. After that, in the event where the user issues a print request to the cloud print service using the mini app for printing within the second app, printing is performed by the registered printer.

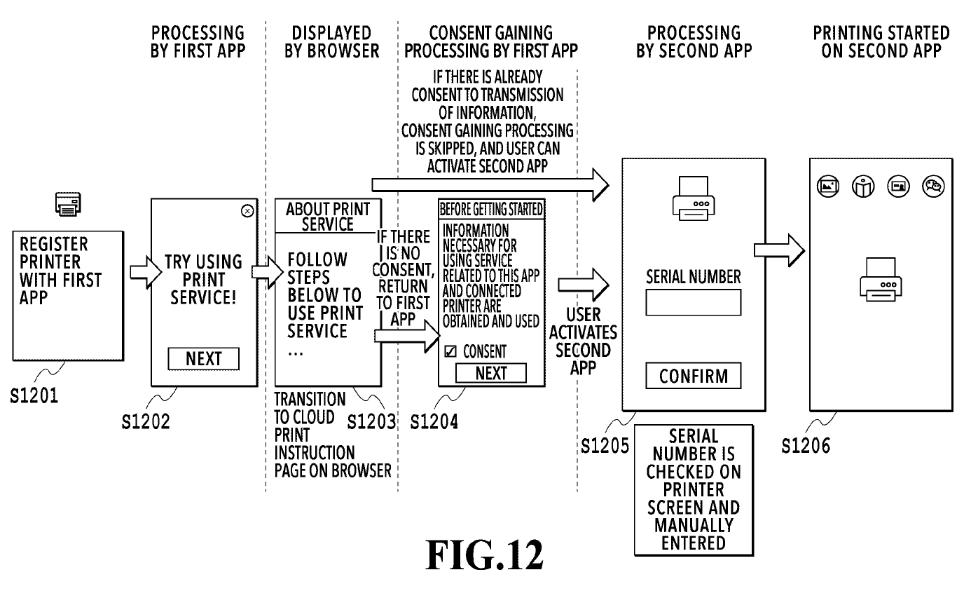

FIG. 12 is a diagram illustrating the above scenario in more detail. Note that FIG. 12 is a diagram illustrating not an example of the present embodiment, but a comparative example. Specifically, FIG. 12 shows a diagram of a comparative example where there is room for improvement in useability.

First, as a premise, a user has a second app (WeChat) installed on their smartphone and has purchased a new printer.

S1201 is processing for preparation. S1201 is processing where the user who has installed the first app into the smartphone connects the printer to a network through a connection setup process (to be described in detail later) and registers the new printer with the first app. Upon completion of the registration of the printer with the first app, an initial screen for starting using the printer is displayed on the smartphone by the first app, as shown in S1202.

Once the user taps on a predetermined button displayed on the first app, a browser on the smartphone displays a webpage introducing cloud printing, as shown in S1203. Also, the webpage displays a description stating that consent to transmission of information is needed in order to print through the second app (WeChat). Seeing this screen on the browser, the user displays the first app again because, as described earlier, processing for gaining user's consent to transmission of information necessary for using the service has to be performed on the first app (print app) communicating with the target printer.

S1204 is an example screen on the first app. In this way, the first app displays a screen in S1202, the browser then displays information in S1203, and the first app then displays a screen again in S1204. Once consent is gained on the first app, the first app notifies the printer that consent has been gained, and the printer notifies the cloud print service of information indicating that the consent has been gained.

Next, the user activates the second app (WeChat) on the smartphone (S1205). The second app receives input of the serial number of the target printer that registered the information indicating that the consent has been gained into the cloud print service. The user performs this inputting of the serial number by checking the serial number on, e.g., a screen on the printer itself and manually inputting the serial number on the smartphone. In a case where the inputted serial number is a valid number, necessary information is communicated between the cloud print service and the mini app for printing within the second app, so that in S1206, printing using the target printer can be performed with the second app.

In this way, in preparation for performing cloud printing using the second app, the serial number of the target printer needs to be inputted on the second app in S1205. This serial number input needs to be done manually by the user. This task is cumbersome and may lower usability. Also, as described in relation to S1202 to S1204, in the process of gaining user's consent to transmission of information necessary for using the service, a switch is made from the first app to the browser, and then a switch is made again to the first app. This processing is also cumbersome and may lower usability.

Thus, in the present embodiment, in a case where consent has yet to be gained, a screen for gaining consent is displayed before displaying an introduction page like the one shown in S1203 on the browser. Also, in displaying an introduction page like the one shown in S1203 on the browser after gaining consent, processing is performed to display the serial number of the target printer on the introduction page (this processing will be described in detail later). Because the introduction page displayed on the browser shows the serial number of the target printer, the user can copy the serial number to the clipboard. Then after the second app (WeChat) is activated as shown in S1205, the user can paste the serial number copied to the clipboard. This allows the user to enter the serial number without having to manually entering it.

Note that some models of a printing apparatus 102 may not support processing for gaining consent on the first app. Thus, depending on the model of the target printer, the first app performs processing for switching between performing the above-described processing and performing different processing. Details will be described later.

Useability can thus be improved. The following gives detailed descriptions of various configurations and processes for implementing the processing described above.

### System Configuration

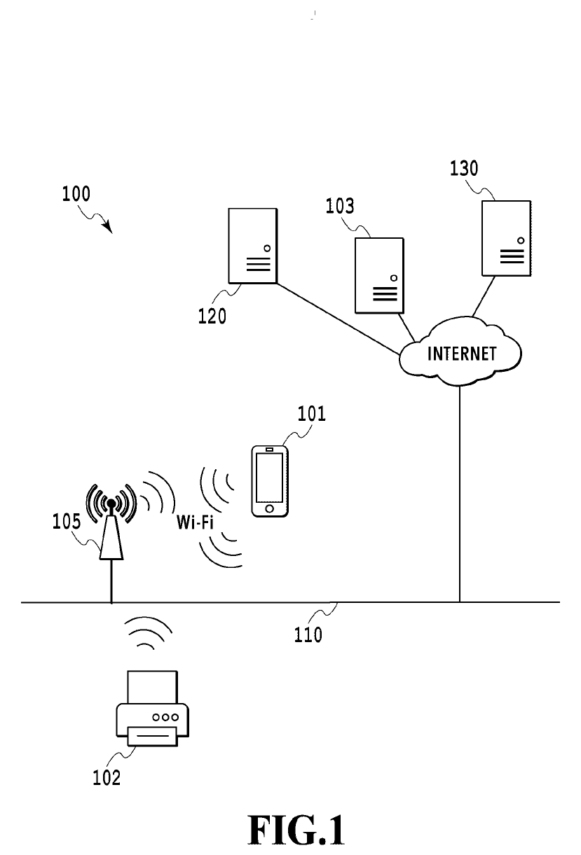

FIG. 1 is a diagram showing an example configuration of an information processing system of the present embodiment. An information system 100 shown in FIG. 1 has a mobile terminal 101, a wireless local area network (LAN) terminal 105, a printing apparatus 102, a print management server apparatus 103, a print service server apparatus 120, and a print service introduction server apparatus 130. These apparatuses, servers, and the like are connected via a network 110. The print management server apparatus 103 and the print service server apparatus 120 are cloud servers hosted on the Internet.

The mobile terminal 101 is a mobile terminal such as a smartphone or a tablet. The mobile terminal 101 is a type of information processing apparatus. An operating system for small terminals and programs for controlling calls and data communications may be running on the mobile terminal 101. Alternatively, the mobile terminal 101 may be a personal computer without audio control, position detection control, mobile phone data communication, or the like. The mobile terminal 101 is connected to the network 110 through the wireless LAN terminal 105.

The printing apparatus 102 is a compact digital multifunction machine for household use including various job execution functions such as a printer function, a copier function, a scanner function, and a fax transmission function. The printing apparatus 102 has a wireless LAN connection function. The printing apparatus 102 can be connected to the network 110 via the wireless LAN terminal 105 by being connected to the mobile terminal 101 through direct connection and having network settings of the printing apparatus 102 configured on the mobile terminal. After the printing apparatus 102 is connected to the network, the user can have the printing apparatus 102 execute various functions by operating the mobile terminal 101 to instruct the printing apparatus 102 to execute a job. Also, after receiving user's consent to transmission of information necessary for using the service, the printing apparatus 102 can now use the print function provided by the print service server apparatus 120. Details will be described later.

Based on a print job from the mobile terminal 101, the print service server apparatus 120 converts (renders) data (e.g., document data) included in the print job into image data. The print service server apparatus 120 then sends the print job including the converted data to the print management server apparatus 103. Also, upon receipt of a serial number from the second app (WeChat) on the mobile terminal 101, the print service server apparatus 120 checks the serial number against the serial number received from the print management server apparatus 103 and sends the result to the second app on the mobile terminal.

The print management server apparatus 103 is a cloud server with a function to manage jobs and information indicating that the user gave consent to transmission of information necessary for using the service from the printing apparatus 102 to an external server (this information is hereinafter also referred to as consent information). The print management server apparatus 103 receives consent information and capability information including a serial number from the printing apparatus 102. The print management server apparatus 103 transfers a notification indicative of completion of consent and the capability information including the serial number to the print service server apparatus 120. Also, the print management server apparatus 103 transmits a print job received from the print service server apparatus 120 to the printing apparatus 102.

As described above, in the present embodiment, the print management server apparatus 103 and the print service server apparatus 120 are cloud servers hosted on the Internet, and the cloud print service is provided by them. Thus, a cloud print service refers to either a service provided by the print management server apparatus 103 and the print service server apparatus 120 or the print management server apparatus 103 and the print service server apparatus 120 themselves. Note that the configurations and roles described above are merely examples, and the present disclosure is not limited to the examples described above.

In the event where a user uses the cloud print service, various kinds of information needs to be transmitted to the cloud print service and managed on the cloud print service end. Examples of the various information include various kinds of information related to the printer and a print job created by the user. In order for the cloud print service to handle such information, the cloud print service needs consent to transmission of information necessary for using the service, as described earlier. "Information necessary for using the service" here includes, for example, information for identifying the user in the cloud print service, information on the mobile terminal 101, information on the printing apparatus 102, and information on the driver or application linked with the printing apparatus 102. The information on the printing apparatus 102 includes the serial number of the printing apparatus 102. "Information necessary for using the service" also includes information on a file to be uploaded and information on the language used by the user. Consent to transmission of such "information necessary for using the service" is called "information transmission consent" herein. By receiving information transmission consent from the user, the printing apparatus 102 can transmit data to the cloud print service from the printing apparatus 102.

Note that the user can give the information transmission consent by operating the mobile terminal 101 or operating the operation unit of the printing apparatus 102 itself. Also, the behavior of the mobile terminal 101 may vary depending on the model of the printing apparatus 102. Details will be described later.

The print service introduction server apparatus 130 is a server that provides a webpage that includes, e.g., information introducing a print service to a user and information on the steps to take to use the print service. The method for using the print service differs depending on the region. For this reason, the print service introduction server apparatus 130 has a suitable introduction page content (webpage) for each country or region. The printing apparatus 102 includes shipping destination information so that the country or region for which the printing apparatus 102 was targeted can be identified. The present embodiment describes an example where the shipping destination of the printing apparatus 102 is a particular country. In the following example, China is assumed as an example of the particular country because the second app (WeChat) described above is widely used in China.

In a case where the shipping destination is China, the print service introduction server apparatus 130 introduces the steps to take to print from the second app as one of print services. For example, the introduction page (webpage) for China provided by the print service introduction server apparatus 130 has descriptions on, e.g., how to install the second app and how to register a mini app for printing into the second app. The user refers to the information being displayed and performs installation of the second app and the like. Also, as described earlier, in order to print from the second app, the user inputs the serial number of the printing apparatus 102 that the user owns on the user interface (UI) displayed by the mini app for printing. The printing apparatus 102 is thereby linked with the print service to use. As a result of the linkage, printing using the printing apparatus 102 can be executed from the second app (WeChat).

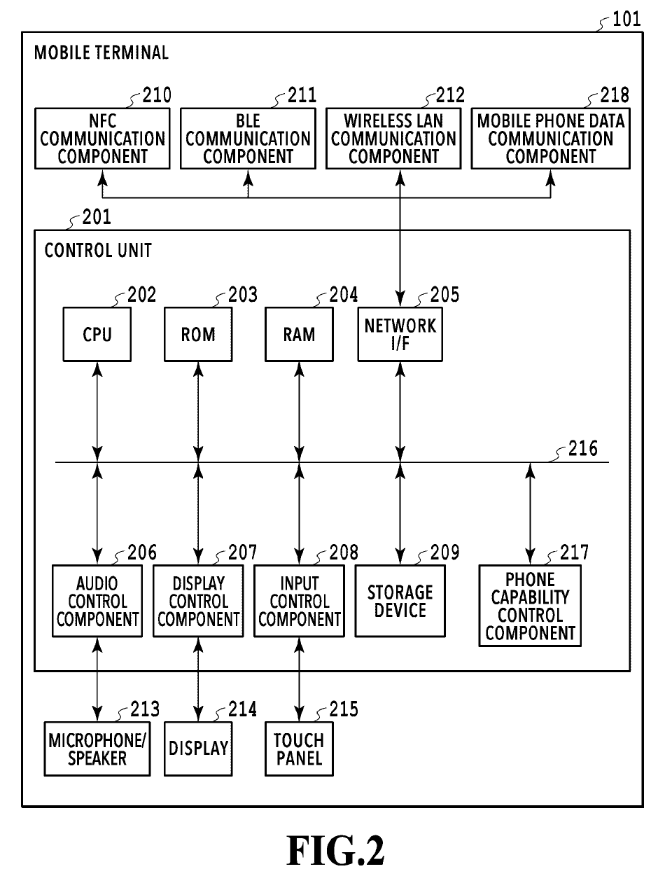

FIG. 2 is a block diagram showing a hardware configuration of the mobile terminal 101 according to the present embodiment. The mobile terminal 101 has a controller unit 201. The controller unit 201 controls various communication components, namely an NFC communication component 210, a Bluetooth Low Energy (BLE) communication component 211, a wireless LAN communication component 212, and a mobile phone data communication component 218, as well as various UI components, namely a microphone/speaker 213, a display 214, and a touch panel 215.

The controller unit 201 has a central processing unit (CPU) 202, read-only memory (ROM) 203, random-access memory (RAM) 204, a network interface (I/F) 205, an audio control component 206, a display control component 207, an input control component 208, a storage device 209, and a phone capability control component 217. The components in the controller unit 201 are connected by a system bus 216.

The CPU 202 performs overall system control of the mobile terminal 101. The operating system of the mobile terminal 101 and applications for controlling calls and data communications are stored in the ROM 203. The RAM 204 is memory used by the CPU 202 to execute various programs and is a working memory area where an application executes a program. The storage device 209 is a nonvolatile storage device and stores various operation mode settings, operation logs, and the like that need to be retained after reactivation of the mobile terminal 101. Also, the ROM 203, the RAM 204, or the storage device 209 can store the first app and the second app described above. Also, the ROM 203, the RAM 204, or the storage device 209 can store a browser application (hereinafter referred to simply as a browser) for displaying a webpage.

The network I/F 205 is connected to the NFC communication component 210, the BLE communication component 211, the wireless LAN communication component 212, and the mobile phone data communication component 218 and performs various controls of wireless communication with the printing apparatus 102, the various server apparatuses, a base station, and the like.

The audio control component 206 controls input and output of audio data via the microphone/speaker 213. The display control component 207 controls output of image data to be displayed on the display 214. The input control component 208 controls input of information instructed by the user using a button or the touch panel 215. Various applications to be executed by the mobile terminal 101 are provided to the user using the audio control component 206, the display control component 207, and the input control component 208. The phone capability control component 217 performs control to allow the user to call the number instructed by the user and communicates with a base station handling telephone lines via the mobile phone data communication component 218.

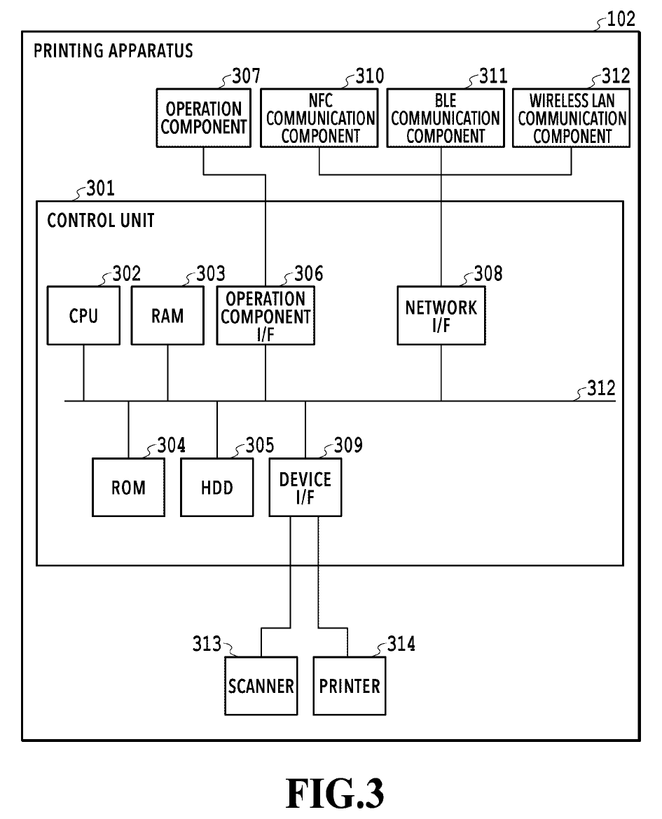

FIG. 3 is a block diagram showing a hardware configuration of the printing apparatus 102 according to the present embodiment. The printing apparatus 102 has a control unit 301. The control unit 301 controls various communication components, namely an NFC communication component 310, a BLE communication component 311, and a wireless LAN communication component 312, as well as an operation component 307, a scanner 313, and a printer 314. In a case where a user uses the copier function, the control unit 301 controls the scanner 313 to obtain image data on an original and controls the printer 314 to print an image on a sheet and output the sheet.

Also, in a case where a user uses the scanner function, the control unit 301 controls the scanner 313 to obtain image data on an original and convert the image data to code data, and transmits the code data to the destination via the network 110. The scan is push scan in a case where the destination is an email address and is pull scan in a case where the destination is the mobile terminal 101 that has instructed the scan.

Also, in a case where the user uses the printer function, the control unit 301 receives print data (code data) from the mobile terminal 101 or via the network 110, converts the received print data to image data as needed, and transmits the image data to the printer 314. The printer 314 prints an image on a sheet based on the received image data and outputs the sheet.

The printing apparatus 102 also has a fax reception function to receive data from ISDN or the like and print the data and a fax transmission function to transmit scanned data to ISDN or the like. An instruction to execute processing for any of these functions is called a job, and the printing apparatus 102 executes predetermined processing according to a job corresponding to a function.

The control unit 301 has a CPU 302, RAM 303, ROM 304, a hard disk drive (HDD) 305, an operation component I/F 306, a network I/F 308, and a device I/F 309, and they are connected by a system bus 316.

The CPU 302 performs overall system control of the printing apparatus 102. The RAM 303 is system work memory for the CPU 302 to operate and is image memory for temporarily storing image data. Programs and data are also stored in the RAM 303, the programs being the operating system, system software, application software, and the like. The RAM 303 also stores scan image data obtained by the scanner 313 and print image data received from the mobile terminal 101 or the print management server apparatus 103 via the network 110. The ROM 304 stores the system's boot program. The HDD 305 stores the operating system, system software, application software, image data, configuration data, and the like.

The operation component I/F 306 is an interface with the operation component 307, and information to display on the operation component 307 is outputted to the operation component 307 therethrough. Also, the operation component I/F 306 receives user-inputted information from the operation component 307.

The network I/F 308 is connected to the NFC communication component 310, the BLE communication component 311, and the wireless LAN communication component 312 and performs various controls of wireless communication with the mobile terminal 101 and various servers. The wireless LAN communication component 312 forms a wireless LAN with the mobile terminal 101 via the network 110. Also, the NFC communication component 310 and the BLE communication component 311 form near field communication with the mobile terminal 101 via radio signals. The printing apparatus 102 transmits and receives job configuration information and image data to and from the mobile terminal 101 through the network I/F 308 and executes a job in response to a command to execute any of the various functions of the printing apparatus 102. Also, in a case where there is a print job in the print management server apparatus 103, the printing apparatus 102 obtains the print job via the network I/F 308 and executes the job.

The device I/F 309 connects the control unit 301 to the scanner 313 for scanning image data or the printer 314 for printing and enables input and output of image data therebetween.

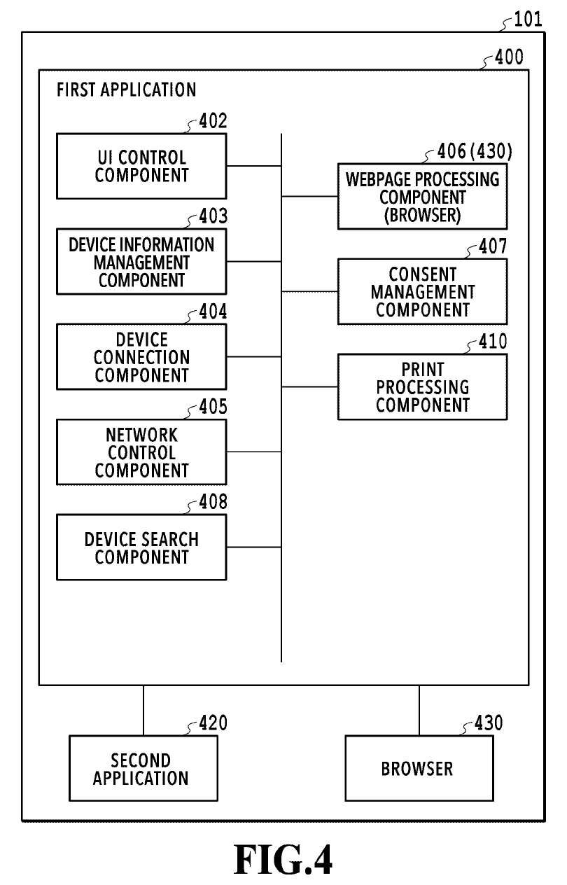

FIG. 4 is a block diagram showing a software configuration of the mobile terminal 101 according to the present embodiment. The mobile terminal 101 has a first application 400, a second application 420, and a browser 430.

The first application 400 is software executed by the CPU 202 of the mobile terminal 101 and is stored in the RAM 204. The first application 400 (hereinafter also referred to as a first app 400) is the first app described earlier and is a print app. The first app 400 has a UI control component 402, a device information management component 403, a device connection component 404, a network control component 405, a webpage processing component 406, a consent management component 407, a device search component 408, and a print processing component 410.

The UI control component 402 receives job settings inputted on the touch panel 215 by the user and transmits them to the print processing component 410 via the input control component 208. Further, the UI control component 402 receives consent or refusal about transmission of information and transmits it to the consent management component 407 via the input control component 208.

The device connection component 404 establishes communication between the mobile terminal 101 and the printing apparatus 102 over the network 110. In a case where the printing apparatus 102 has the access point function activated, the mobile terminal 101 can establish a direct connection with the printing apparatus 102.

The network control component 405 transmits a command to obtain device settings information, a command to reflect the device settings information, or the like to the printing apparatus 102 via the network 110. The network control component 405 further receives a response to a transmitted command via the network 110.

The webpage processing component 406 interprets a uniform resource locator (URL), and the UI control component 402 displays the result. The webpage processing component 406 is an internal browser included in the first app 400. Note that because the same processing is performed irrespective of an in-app browser or an out-of-app browser, they are both collectively referred to simply as the browser 430 hereinbelow. Specifically, as long as the mobile terminal 101 has a browser function, the browser 430 may be a browser within the first app 400 or a browser application different from the first app 400.

The device search component 408, using the network control component 405, searches for an image formation apparatus existing on the network. The device search component 408 also obtains configuration information on the printing apparatus 102 simultaneously with the search.

The device information management component 403 stores device information on the device selected by the user from the devices found by the device search component 408. The device information includes configuration information on the device.

The print processing component 410 processes a print job transmitted from the UI control component 402 and transmits the print job to the printing apparatus 102 or the print service server apparatus 120.

The consent management component 407 manages information transmission consent information received by the UI control component 402.

The second application 420 (hereinafter also referred to as a second app 420) is the second app described earlier and is, for example, an SNS app. The browser 430 is an app that receives a webpage indicated by the URL from a server and displays the webpage.

The first app 400, the second app 420, and the browser 430 shown in FIG. 4 are each implemented by the CPU 202 by loading a program corresponding to the app into the RAM 204 and executing the program, the program stored in the storage device 209, or the like.

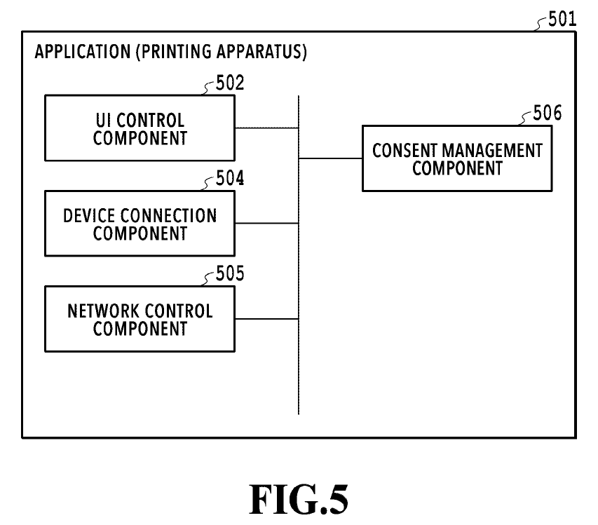

FIG. 5 is a block diagram showing a software configuration of the printing apparatus 102 according to the present embodiment. An application 501 has a UI control component 502, a device connection component 504, a network control component 505, and a consent management component 506. The application 501 is software executed by the CPU 302 of the printing apparatus 102 and is stored in the RAM 303, the HDD 305, or the like.

The UI control component 502 performs response processing based on an operation inputted by the user through the operation component 307 and outputs the response to the operation component 307. For example, the UI control component 502 receives activation of the access point function for direct connection, activates the access point function, and then displays information on the access point on the operation component 307.

The device connection component 504 establishes network communication between the mobile terminal 101 and the printing apparatus 102 over the network 110. The network control component 505 receives a print job, a consent information write command, and the like from the mobile terminal 101 via the network 110.

The consent management component 506 receives writing of the consent information from the UI control component 502 or the mobile terminal 101 and saves consent information. Also, in registration of a device (the printing apparatus 102) with the print management server apparatus 103, the consent management component 506 transmits the consent information to the print management server apparatus 103 as well. In this way, the consent information may be obtained based on an operation performed on the mobile terminal 101 or an operation performed on the printing apparatus 102 itself.

### Screen Transition

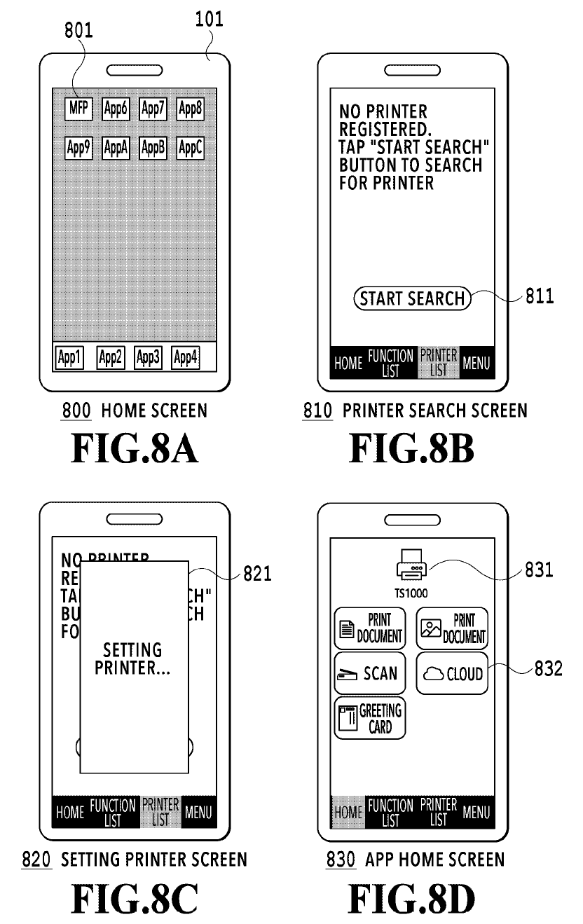

FIGS. 8A to 10C are diagrams showing example screens displayed on the mobile terminal 101. Using FIGS. 8A to 10C, descriptions are given of examples of how the screen displayed on the display 214 of the mobile terminal 101 transitions from receiving consent about transmission of information to displaying a webpage for a print service.

Once the mobile terminal 101 is activated, the mobile terminal 101 displays a home screen 800 shown in FIG. 8A. A multifunction printer (MFP) app icon 801 is an icon indicative of the first app 400, i.e., a print app. Once the MFP app icon 801 is tapped, the mobile terminal 101 activates the first app 400. Note that although tapping is used as an example of a pressing operation in the present embodiment, a pressing operation may be clicking or the like.

Once the first app 400 is activated, the screen on the mobile terminal 101 is one displayed by the first app 400. The screen displayed after activation of the first app 400 is a printer search screen 810 shown in FIG. 8B. The printer search screen 810 includes a Start Search button 811. Once the Start Search button 811 is tapped, a printer search is started, and the screen by the first app 400 transitions to a Setting a Printer screen 820 shown in FIG. 8C. The Setting a Printer screen 820 shown in FIG. 8C displays a notification 821 indicative of the fact that a printer is being set up. On the Setting a Printer screen 820, a search for a printer and configuration of the settings of the printer found (the printing apparatus 102) are performed. During the initial setup, the printing apparatus 102 activates an access point for setup. Thus, the mobile terminal 101 connects to the access point for setup activated by the printing apparatus 102 and configures network settings, and as a result, the printing apparatus 102 is connected to the wireless LAN terminal 105 for infrastructure connection. Details of the infrastructure connection will be described later. Such initial configuration of network settings is referred to as a connection setup process. Details of a wireless setup will be described later.

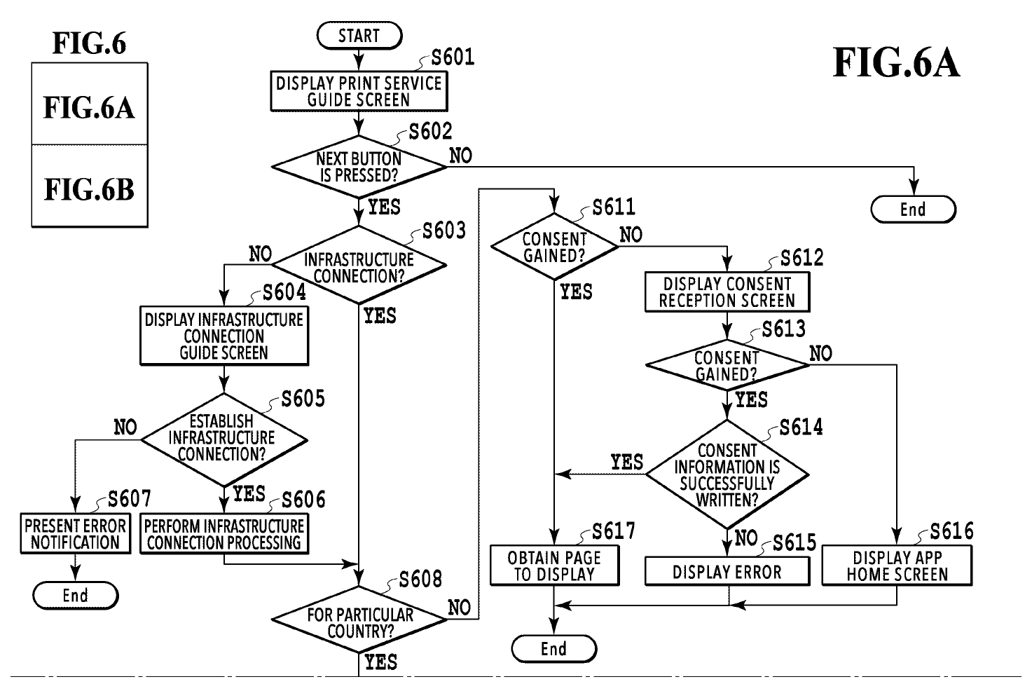

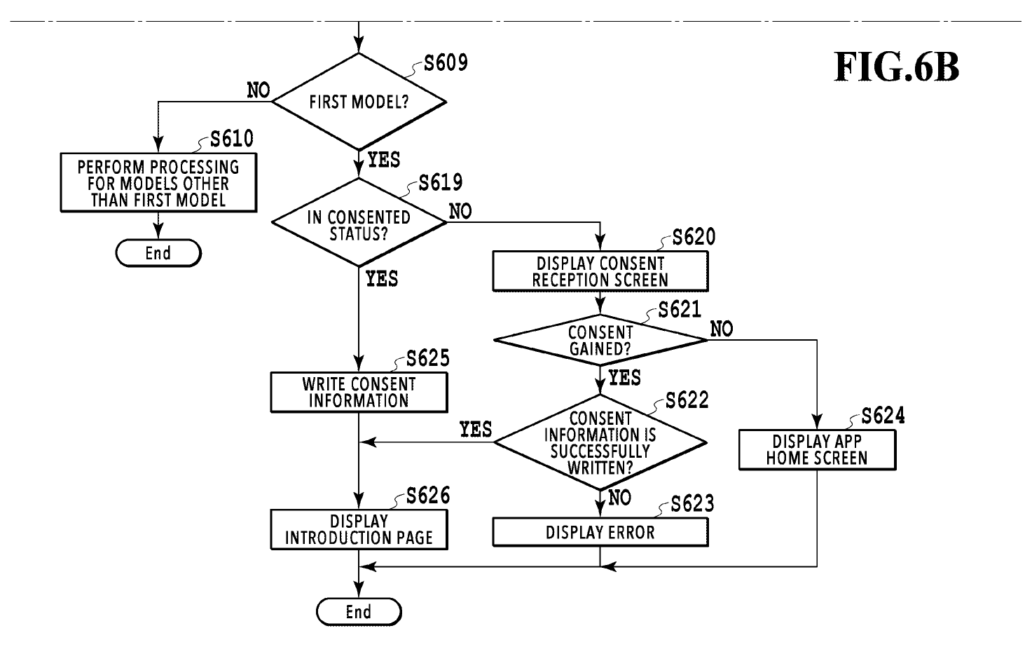

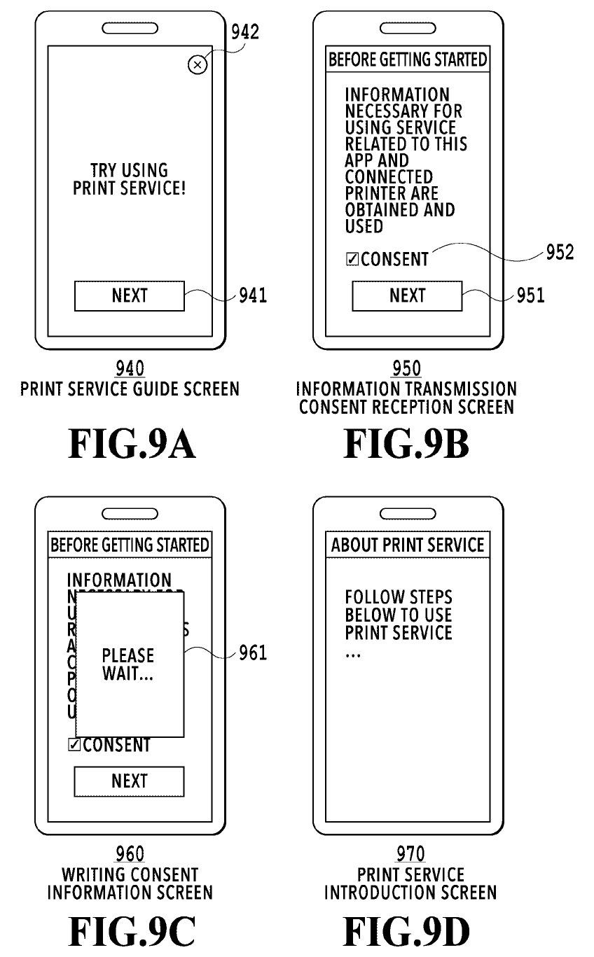

Once configuration of various settings is completed, the screen displayed by the first app 400 transitions to an app home screen 830. The app home screen 830 displays a printer icon 831. The printer icon 831 shows the device (the printing apparatus 102) having been set up by the mobile terminal 101 and currently being selected by the first app 400. Note that in the present embodiment, upon completion of configuration of network settings as the initial setup, the first app 400 displays not the app home screen 830, but a print service guide screen 940 shown in FIG. 9A. Then, the first app 400 displays the app home screen 830 after completion of processing in FIGS. 6A and 6B to be described later.

The print service guide screen 940 shown in FIG. 9A displays a message guiding the user to use the print service. This print service guide screen 940 is a screen equivalent to the screen displayed in S1202 in the flowchart described briefly at the beginning of the embodiment. Note that as described earlier, in the comparative example not according to the present embodiment, in response to a Next button 941 being pressed, the first app determines the shipping destination of the printer apparatus, and in a case where the shipping destination is a particular country (e.g., China), activates the browser 430 and displays an introduction page. In the present embodiment, by contrast, in response to the Next button 941 being pressed, the first app 400 determines the shipping destination of the printer apparatus, and in a case where the shipping destination is a particular country, transitions to an information transmission consent reception screen 950 shown in FIG. 9B. In other words, instead of activating the browser 430 and displaying the introduction page, the first app 400 performs processing for displaying the information transmission consent reception screen 950. Note that in the event where a Cancel button 942 is pressed on the print service guide screen 940, the screen transitions to the app home screen 830 of the first app 400.

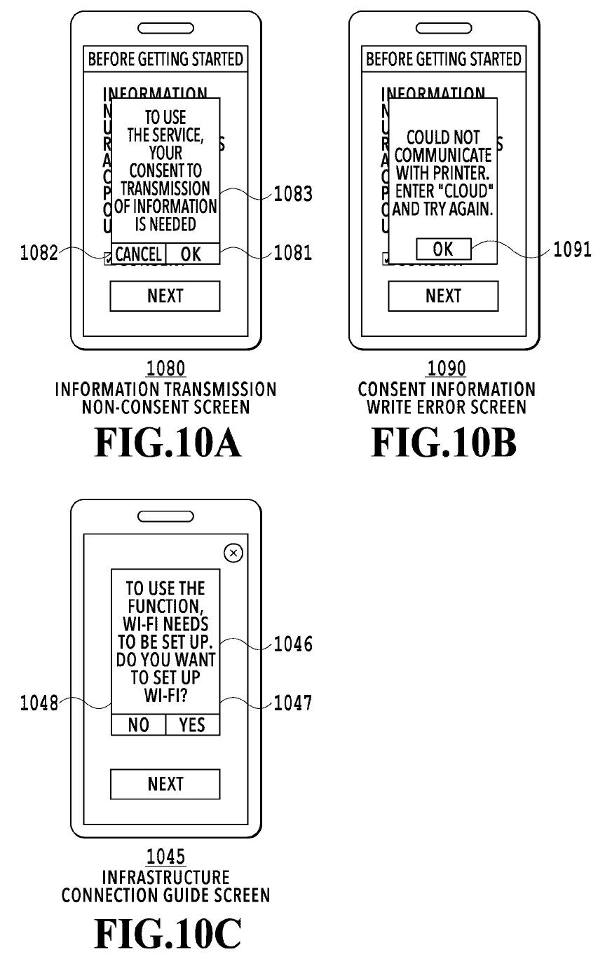

Note that in a case where the first app 400 is connected to the printing apparatus 102 by direct connection in the event where the Next button 941 is pressed on the print service guide screen 940, the first app 400 displays an infrastructure connection guide screen 1045 shown in FIG. 10C. The printing apparatus 102 cannot communicate with the cloud server unless the printing apparatus 102 is connected by infrastructure connection, and thus, a switch needs to be made to infrastructure connection. On the infrastructure connection guide screen 1045, the first app 400 displays a message 1046 notifying that infrastructure connection needs to be established and checking whether to establish infrastructure connection. Upon receipt of input of a YES button 1047, the first app 400 performs infrastructure connection switch processing, and then the screen displayed by the first app 400 transitions to the information transmission consent reception screen 950 shown in FIG. 9B. By contrast, upon receipt of input of a NO button 1048, the first app 400 displays an error message (not shown), and the screen by the first app 400 transitions back to the app home screen 830.

On the information transmission consent reception screen 950 shown in FIG. 9B, the first app 400 receives the user's consent to transmission of information. Upon pressing of a Next button 951 with a Consent checkbox 852 checked, the first app 400 determines that consent to information transmission has been gained and transitions to a Writing Consent Information screen 960 shown in FIG. 9C. Upon pressing of the Next button 951 with the Consent checkbox 852 unchecked, the first app 400 transitions to an information transmission non-consent screen 1080 shown in FIG. 10A. On the Writing Consent Information screen 960, the first app 400 displays a message 961 asking the user to wait because writing is currently being performed. Meanwhile, the first app 400 performs control to communicate with the printing apparatus 102 and write the consent information into the printing apparatus 102. After that, if the consent information is successfully written into the printing apparatus 102, the first app 400 has the browser 430 display a print service introduction screen 970 shown in FIG. 9D. The print service introduction screen 970 is therefore a screen displayed by the browser 430. If, conversely, writing of the consent information into the printing apparatus 102 fails, the first app 400 transitions to a consent information write error screen 1090 shown in FIG. 10B.

On the information transmission non-consent screen 1080, the first app 400 displays a message 1083, notifying the user that they cannot use the print service unless they give consent. Upon pressing of an OK button 1081, the first app 400 transitions back to the information transmission consent reception screen 950. Upon pressing of a Cancel button 1082, the first app 400 transitions to the app home screen 830.

On the consent information write error screen 1090 shown in FIG. 10B, the first app 400 notifies the user that writing of the consent information has failed. Upon pressing of an OK button 1091 on the consent information write error screen 1090, the first app 400 transitions back to the app home screen 830.

Note that the above description about screen transition shows an example where the first app 400 displays the information transmission consent reception screen 950 shown in FIG. 9B after the print service guide screen 940. The information transmission consent reception screen 950 is displayed in a case where the user has not given consent by operating the printing apparatus 102 itself. In a case where the user has already given consent by operating the printing apparatus 102 itself, upon pressing of the Next button 941 on the print service guide screen 940, the first app 400 has the browser 430 display the print service introduction screen 970. In other words, in a case where the user has already given consent by operating the printing apparatus 102 itself, the first app 400 does not display the information transmission consent reception screen 950.

### Initial Setup

The following describes the connection setup process performed between the first app 400 on the mobile terminal 101 and the printing apparatus 102 (also referred to as a cableless setup because it is a setup using no cable).

### Direct Connection Method

Direct connection refers to a mode where apparatuses are connected to each other wirelessly in a direct (i.e., peer-to-peer) manner without intervention of an external apparatus such as the wireless LAN terminal 105. Direct connection is also called peer-to-peer (P2P) connection. The printing apparatus 102 can operate in a mode communicating through direct connection (direct connection mode) as one of connection modes. There are a plurality of modes communicating through direct connection in Wi-Fi communication, such as software access point (AP) mode and Wi-Fi Direct (WFD) mode.

A mode that establishes direct connection using WFD is called WFD mode. WFD is a standard developed by the Wi-Fi Alliance and is included in IEEE802.11 series of communication standards. In WFD mode, after a device to communicate with is found by a device search command, the roles as a P2P group owner (GO) and a P2P client are determined, and then the rest of the wireless connection process is performed. The group owner corresponds to the Wi-Fi parent station (parent device), and the client corresponds to the Wi-Fi child station (child device). This role determination corresponds to, for example, GO Negotiation in P2P. Note that in WFD mode before the role determination, the printing apparatus 102 is neither a parent station nor a child station. Specifically, one of the devices to communicate with each other issues a device search command and searches for the device to connect to in WFD mode. Once the other device to be communicated with is found, the devices check information on a service and a function that can be supplied between them. Note that this device supply information checking is optional, not essential. This device supply information checking phase corresponds to, for example, Provision Discovery in P2P. Next, by checking the device supply information with each other, their roles are determined: a P2P client or a P2P group owner. Next, once the client and the group owner are determined, parameters for WFD communication are exchanged between them. Based on the parameters thus exchanged, the rest of the wireless connection process and the IP connection process are performed between the P2P client and the P2P group owner. Note that in WFD mode, the printing apparatus 102 may always act as the group owner without executing the above-described GO Negotiation. In other words, the printing apparatus 102 may operate in WFD mode in Autonomous GO mode. The state where the printing apparatus 102 operates in WFD mode is, for example, a state where the printing apparatus 102 is acting as the group owner with no WFD connection established or a state where the printing apparatus 102 is acting as the group owner with WFD connection established.

In software AP mode, between the devices to communicate with each other (e.g., the mobile terminal 101 and the printing apparatus 102), one of the devices (e.g., the mobile terminal 101) acts as a client that requests various services. Then, the other device implements an AP function in Wi-Fi based on software settings. The software AP corresponds to the Wi-Fi parent station, and the client corresponds to the Wi-Fi child station. In software AP mode, the client searches for the device to be the software AP using a device search command. Once the software AP is found, the client and the software AP perform the rest of the wireless connection process (such as establishing wireless connection) and then perform IP connection processing (such as IP address allocation). Note that commands and parameters transmitted and received in implementing wireless connection between the client and the software AP may be ones defined in the Wi-Fi standards and are not described here.

In the present embodiment, in a case where the printing apparatus 102 establishes and maintains direct connection, the printing apparatus 102 acts as a parent station in the network to which the printing apparatus 102 belongs. Note that the parent station is a device that builds a wireless network and provides a child station with a parameter to use to connect to the wireless network. The parameter to use to connect to the wireless network is, for example, a parameter related to the channel used by the parent station. By receiving this parameter, the child station connects to the wireless network built by the parent station using the channel used by the parent station. Because the printing apparatus 102 acts as the parent station in direct connection mode, the printing apparatus 102 can determine which frequency band to use and which channel to use for communications in direct connection mode. In the present embodiment, for communications in direct connection mode, the printing apparatus 102 can use a channel corresponding to the 2.4 GHz frequency band and a channel corresponding to the 5 GHz frequency band.

### Infrastructure Connection Method

Infrastructure connection is a connection mode where the devices to communicate with each other (e.g., the mobile terminal 101 and the printing apparatus 102) connect to an AP (e.g., the wireless LAN terminal 105) performing overall control of their network and communicate via the AP. The printing apparatus 102 can also operate in a mode communicating through infrastructure connection (infrastructure connection mode) as one of the connection modes.

In infrastructure connection, each device searches for an AP using a device search command. Once an AP is found, the device and the AP perform the rest of the wireless connection process (such as establishing wireless connection) and then after that, perform IP connection processing (such as allocating an IP address). Note that the command and parameter transmitted and received in implementing wireless connection between the device and the AP may be ones defined in the Wi-Fi standards and are not described here.

In the present embodiment, in a case where the printing apparatus 102 operates by infrastructure connection, the wireless LAN terminal 105 acts as a parent station, and the printing apparatus 102 acts as a child station. Thus, in the present embodiment, infrastructure connection refers to connection between the printing apparatus 102 acting as a child station and an apparatus acting as a parent station. In a case where the printing apparatus 102 has established infrastructure connection and the mobile terminal 101 too has established infrastructure connection with the wireless LAN terminal 105, the printing apparatus 102 and the mobile terminal 101 can communicate with each other via the wireless LAN terminal 105. Because the channel used by communications through infrastructure connection is determined by the wireless LAN terminal 105, the printing apparatus 102 executes communications through infrastructure connection using the channel determined by the wireless LAN terminal 105. In the present embodiment, for communications through infrastructure connection, the printing apparatus 102 can use a channel corresponding to the 2.4 GHz frequency band and a channel corresponding to the 5 GHz frequency band. Note that for communications through infrastructure connection, the printing apparatus 102 can also use a channel corresponding to the DFS band in the 5 GHz frequency band. Note that in order to communicate with the printing apparatus 102 via the wireless LAN terminal 105, the mobile terminal 101 recognizes and identifies that the printing apparatus 102 belongs to the network which is formed by the wireless LAN terminal 105 and to which the mobile terminal 101 belongs.

### Connection Setup Process

In the present embodiment, the mobile terminal 101 executes connection setup (configuration of network settings) by wirelessly communicating with the printing apparatus 102, the connection setup being a setup performed for the printing apparatus 102 to operate in at least one of the communication methods: infrastructure connection or direct connection. The connection setup process in the present embodiment is also called cableless setup (CLS) because it is executed through wireless communication. Note that the connection setup process may be executed through wired communication. The mobile terminal 101 performs the connection setup process for the printing apparatus 102 while the first app 400 is activated. The printing apparatus 102 can operate in connection setup mode (connection setup state), which is a mode for executing the connection setup process, and the connection setup process is executed with the printing apparatus 102 operating in the connection setup mode. Details of the connection setup mode will be described later.

To have the printing apparatus 102 operate in infrastructure connection mode, the mobile terminal 101 wirelessly transmits infrastructure connection setup information to the printing apparatus 102, the infrastructure connection setup information being setup information used to have the printing apparatus 102 operate in infrastructure connection mode. The infrastructure connection setup information includes information related to the wireless LAN terminal 105. Information related to the wireless LAN terminal 105 is, for example, a Service Set Identifier (SSID), a password, and frequency band information.

By contrast, to have the printing apparatus 102 operate in direct connection mode, the mobile terminal 101 wirelessly transmits direct connection setup information to the printing apparatus 102, the direct connection setup information being setup information used to have the printing apparatus 102 operate in direct connection mode. The direct connection setup information includes instructions for enabling the WFD function so that the printing apparatus 102 will act as the group owner and for enabling the access point setting of the printing apparatus 102. Also, from the printing apparatus 102, the mobile terminal 101 obtains connection information necessary for directly connecting to the printing apparatus 102. The connection information necessary for directly connecting to the printing apparatus 102 includes information such as, for example, the SSID and password of the printing apparatus 102 operating in direct connection mode.

In the present embodiment, direct connection for connection setup between the mobile terminal 101 and the printing apparatus 102 is used for the transmission of the infrastructure connection setup information and the direct connection setup information and for the obtainment of the information necessary for directly connecting to the printing apparatus 102 in the connection setup process. Then, as the direct connection for connection setup, the connection setup process is executed using Wi-Fi in the present embodiment. However, wireless communication standards other than Wi-Fi, such as Bluetooth, may be used. Also, wired communication standards such as a wireless LAN or Universal Serial Bus (USB) may be used as the direct connection for connection setup.

After infrastructure connection or direct connection is established by Wi-Fi between the mobile terminal 101 and the printing apparatus 102 through the connection setup process, the mobile terminal 101 and the printing apparatus 102 can communicate with each other through the connection thus established. Specifically, for example, the mobile terminal 101 can transmit a print job for having the printing apparatus 102 print and a scan job for having the printing apparatus 102 scan to the printing apparatus 102 through the established connection. Note that as a result of the connection setup process, the printing apparatus 102 can operate in infrastructure connection mode or in direct connection mode in the present embodiment; however, the present disclosure is not limited to this. For example, the connection setup process can cause the printing apparatus 102 to operate only in infrastructure connection mode (i.e., the printing apparatus 102 cannot operate in direct connection mode).

### Connection Setup Mode

The printing apparatus 102 can operate in connection setup mode. The trigger for the printing apparatus 102 to start operating in connection setup mode may be, for example, the user pressing a Connection Setup Mode button or the printing apparatus 102 being activated (powered on) for the first time since arrival. The Connection Setup Mode button may be a hardware button on the printing apparatus 102 or a software button displayed by the printing apparatus 102 on the operation component 307.

Once starting to operating in connection setup mode, the printing apparatus 102 enables both of Wi-Fi communication and BLE communication. Specifically, as processing to enable Wi-Fi communication, the printing apparatus 102 enables an AP dedicated to connection setup mode (a connection setup AP) inside the printing apparatus 102. This brings the printing apparatus 102 into a state of being able to establish direct connection with the mobile terminal 101 through Wi-Fi. The connection information (an SSID and a password) required to connect to the connection setup AP is pre-stored in the first app 400 installed on the mobile terminal 101. In other words, the mobile terminal 101 already recognizes the connection information required to connect to the connection setup AP. Thus, unlike the connection information on the AP enabled in direct connection mode, the connection information required to connect to the connection setup AP cannot be freely changed by the user. As an alternative form, no password may be required to connect to the AP because no encryption method may is set for the connection setup AP. Also, in connection setup mode, the printing apparatus 102 may connect to the mobile terminal 101 not through regular Wi-Fi, but through Wi-Fi Direct (WFD). Specifically, the printing apparatus 102 may act as the group owner and receive a setup command from the mobile terminal 101 through WFD communication. Also, in a case where, e.g., the printing apparatus 102 does not have a BLE communication function, the printing apparatus 102 may enable only Wi-Fi communication while operating in connection setup mode.

### Registration of the Communication Apparatus with the First App

In the present embodiment, the first app 400 can register the printing apparatus 102 with the first app 400 by obtaining information related to the printing apparatus 102 from the printing apparatus 102. The information related to the printing apparatus 102 include, for example, capability information on the printing apparatus 102, identification information on the printing apparatus 102 (such as a MAC address), and model information on the printing apparatus 102. Specific examples of the capability information on the printing apparatus 102 include information on a list of functions supported by the printing apparatus 102, information on consumables (ink and sheet) usable with the printing apparatus 102, and information on the printing method employed by the printing apparatus 102. The capability information also includes a serial number for uniquely identifying the printing apparatus 102, supported print management server information for identifying the supported types of print management server apparatuses, and the like. The information related to the printing apparatus 102 also includes information indicating whether the printing apparatus 102 is in consented status. The consented status is a status where consent information is written in the printing apparatus 102 after the user performs an operation on the screen displayed by the printing apparatus 102 or the mobile terminal 101 to give consent to transmission of information necessary for using the service. The printing apparatus 102 is not in consented status in a case where consent information is not written in the printing apparatus 102 because the user has not performed an operation on the screen displayed by the printing apparatus 102 or the mobile terminal 101 to give consent to transmission of information necessary for using the service. Note that the consent to transmission of information may change between the time of registration of the printing apparatus 102 with the first app 400 and the time after that. Thus, even in a case where information indicating whether the printing apparatus 102 is in consented status has already been obtained at the time of registration of the printing apparatus 102 with the first app 400, the first app 400 performs the following control. Specifically, the first app 400 is configured to obtain the information from the printing apparatus 102 at the time of displaying a screen for receiving consent on the first app 400 as well.

From one or more printing apparatuses 102 registered with the first app 400, the first app 400 selects an apparatus with which the first app 400 is to communicate. The printing apparatus 102 currently being selected as an apparatus with which the first app 400 communicates is hereinafter referred to as a currently-selected printing apparatus 102. Note that the selection of the apparatus with which the first app 400 communicates may be executed by receiving the user's selection of an apparatus from the one or more printing apparatuses 102 registered with the first app 400. Alternatively, the selection may be executed automatically by the first app 400 according to predetermined criteria. Also, the apparatus with which the first app 400 communicates may be changed by, for example, receiving the user's selection of an apparatus from the one or more printing apparatuses 102 registered with the first app 400. In the present embodiment, the first app 400 transmits any of various jobs, such as a print job or a scan job, to the currently-selected printing apparatus 102. In other words, the currently-selected printing apparatus 102 is an apparatus to which various jobs are transmitted.

In the registration processing, the first app 400 searches for the printing apparatus 102 and establishes direct connection. Specifically, the first app 400 detects an SSID for setup activated by the printing apparatus 102 and performs connection to the SSID. Connection to the SSID for setup can be done without a password.

Next, the first app 400 configures network settings of the printing apparatus 102. For example, the first app 400 configures the settings by transmitting, to the printing apparatus 102, the SSID and password of the wireless LAN terminal to which the mobile terminal 101 is currently connected. Note that the first app 400 may configure the settings by displaying a UI (not shown), receiving network information from the user, and transmitting the received information to the printing apparatus 102.

Next, the first app 400 searches for the printing apparatus 102 the network settings of which have been configured and registers the printing apparatus 102 with the first app 400. Next, the first app 400 obtains capability information on the printing apparatus 102. As described earlier, the capability information includes the serial number uniquely identifying the printer, supported print management server information for identifying the supported types of print management server apparatuses, and the like, in addition to printing capability information such as color or monochrome. The information indicating whether the printing apparatus 102 is in consented status is also obtained at this timing as described earlier, but as will be described later, this information is obtained again at the time of determining whether the printing apparatus 102 is in consented status.

In this way, the first app 400 can start using the printing apparatus 102 by registering the printing apparatus 102 with the first app 400 and selecting the printing apparatus 102 on the first app 400. The above-described process is the initial setup (configuration of network settings) that the user who purchased the printing apparatus 102 performs with the printing apparatus 102 using the mobile terminal 101. The processing to be described below is assumed to be performed after completion of the connection setup process between the first app 400 and the printing apparatus 102.

### Process Flow from Obtaining Consent to Transmission of Information to Displaying the Print Service Introduction Page

FIGS. 6A and 6B are totally a diagram showing a flowchart of example processing performed by the mobile terminal 101. More specifically, FIGS. 6A and 6B are totally a flowchart executed by the first app 400 on the mobile terminal and shows a process flow from obtaining content to transmission of information to displaying the print service introduction page, as controlled by the first app 400.

The flowchart in FIGS. 6A and 6B is implemented by the CPU 202 of the mobile terminal 101 loading a program for the first app 400 stored in the ROM 203, the storage device 209, or the like into the RAM 204 and executing the program. Note that some or all of the functions in the steps in FIGS. 6A and 6B may be implemented by hardware such as an application-specific integrated circuit (ASIC) or an electric circuit. The letter "S" in a description of each process means that it is a step in the flowchart (this applies to the rest of the flowcharts herein as well). The flowchart shown in FIGS. 6A and 6B is processing started by the following trigger: the mobile terminal 101 becoming able to communicate with the printing apparatus 102 by making a search and finding the printing apparatus 102 on the network to which the mobile terminal 101 belongs after the above-described connection setup process is completed.

Although the CPU 202 functioning as the first app 400 is the actual processing entity performing the flowchart shown in FIGS. 6A and 6B, the first app 400 is described below as being the processing entity performing the flowchart to simplify the description.

In S601, the first app 400 displays the print service guide screen 940. In S602, the first app 400 determines whether the Next button 941 has been pressed on the print service guide screen 940. If it is determined that the Next button 941 has been pressed, the first app 400 proceeds to S603, and if it is determined that the Next button 941 has not been pressed, i.e., the Cancel button 942 has been pressed, the processing shown in FIGS. 6A and 6B is ended.

In S603, the first app 400 determines whether the mobile terminal 101 and the printing apparatus 102 are connected by infrastructure connection. Note that a specific example of a state where the mobile terminal 101 and the printing apparatus 102 are not connected by infrastructure connection is a state where the mobile terminal 101 and the printing apparatus 102 are connected by direct connection. For example, this determination is specifically performed as follows: the first app 400 obtains the IP address of the printing apparatus 102 and determines whether this IP address is one corresponding to infrastructure connection or one corresponding to direct connection. If it is determined that they are connected by infrastructure connection, the first app 400 proceeds to S608, and if it is determined that they are not connected by infrastructure connection, i.e., they are connected by direct connection, the first app 400 proceeds to S604.

In S604, the first app 400 displays the infrastructure connection guide screen 1045 and proceeds to S605. This is because infrastructure connection is necessary for registration of the printing apparatus 102 with the cloud print service as described earlier. In S605, the first app 400 determines whether to establish infrastructure connection based on an operation performed on the infrastructure connection guide screen 1045. If it is determined to establish infrastructure connection, the first app 400 proceeds to S606, and if it is determined not to establish infrastructure connection, the first app 400 proceeds to S607. Specifically, if pressing of the YES button 1047 is received on the infrastructure connection guide screen 1045, the first app 400 proceeds to S606, and if pressing of the NO button 1048 is received, the first app 400 proceeds to S607. In S606, the first app 400 executes processing for establishing infrastructure connection. Specifically, as the processing for establishing infrastructure connection, the first app 400 executes the connection setup process and thereby transmits infrastructure connection setup information to the printing apparatus 102 wirelessly. The first app 400 searches for the printing apparatus 102 on the network to which the mobile terminal 101 belongs, and the first app 400 proceeds to S608 in a case where the printing apparatus 102 is found and the mobile terminal 101 and the printing apparatus 102 become able to communicate with each other. In S607, the first app 400 displays an error message (not shown) to notify that the cloud print service cannot be used with direct connection, and ends the processing in the flowchart shown in FIGS. 6A and 6B.

In S608, the first app 400 determines whether the printing apparatus 102 is an apparatus for a particular country. A particular country is defined based on whether it is a target country to which to introduce the print service through the second app 420. An example of the particular country is China. Note that the first app 400 determines whether the printing apparatus 102 is an apparatus for a particular country based on the shipping destination information included in the information obtained from the printing apparatus 102 at the time of registration of the printing apparatus 102 with the first app 400. If it is determined that the printing apparatus 102 is an apparatus for the particular country, the first app 400 proceeds to S609. If it is determined that the printing apparatus 102 is not an apparatus for the particular country, i.e., an apparatus shipped to a destination other than the particular destination, the first app 400 proceeds to S611. Note that the processing in S608 may be omitted. Specifically, for example, control for switching processing to perform based on the destination of the printing apparatus 102 does not have to be executed. In this case, for example, after S603 or S606, processing in S608 is skipped, and S609 is executed.

In S609, the first app 400 determines whether the printing apparatus 102 is a first model. Note that the first app 400 determines whether the printing apparatus 102 is a first model based on model information included in the information obtained from the printing apparatus 102 at the time of registration of the printing apparatus 102 with the first app 400. Descriptions of a first model, a second model, and a third model are given here. The printing apparatus 102 can be the first model, the second model, or the third model. The first and second models are models supporting the cloud print service, whereas the third model is a model not supporting the cloud print service. The first model is a model capable of notifying the first app 400 of information indicating whether the printing apparatus 102 is in consented status. The second mode is a model incapable of notifying the first app 400 of information indicating whether the printing apparatus 102 is in consented status. Note that in the present embodiment, there are a plurality of types of the print management server apparatus 103. Then, because the first model and the second model support different types of the print management server apparatus 103, they can be said to be models supporting different print management server apparatuses 103. The first app 400 can determine whether the printing apparatus 102 is the first model, the second model, or the third model based on the model name of the printing apparatus 102. If it is determined that the printing apparatus 102 is the first model, the first app 400 proceeds to S619, and if it is determined that the printing apparatus 102 is not the first model, the first app 400 proceeds to S610. In S610, the first app 400 performs processing to be executed in a case where the printing apparatus 102 is not the first model and then ends the processing in the flowchart shown in FIGS. 6A and 6B. Processing performed in S610 will be described later. The following description focuses on the case where the printing apparatus 102 is the first model.

In S619, the first app 400 determines whether the printing apparatus 102 is in consented status having consent about transmission of information. This processing is the same as S611. As described earlier, although the first app 400 has already obtained information indicating whether the printing apparatus 102 is in consented status at the timing of registration of the printing apparatus 102 with the first app 400, the consented status may have been changed since the registration by an operation performed on the printing apparatus end. Specifically, the printing apparatus may have been changed from consented status to non-consented status or vice versa due to an operation performed on the printing apparatus end with no intervention of the first app 400. Thus, in S619, the first app 400 obtains information indicating whether the printing apparatus 102 is in consented status from the printing apparatus 102 and makes the determination using this information. If it is determined that the printing apparatus 102 is in consented status, the first app 400 proceeds to S625, and if it is determined that the printing apparatus 102 is not in consented status, the first app 400 proceeds to S620.

In S620, the first app 400 displays the information transmission consent reception screen 950 and receives a user operation for consent or refusal. Next in S621, the first app 400 determines whether an operation for consent has been received on the consent reception screen 950. If an operation for consent has been received, the first app 400 writes consent information into the printing apparatus 102 and stores information indicating that the printing apparatus 102 is in consented status having consent about transmission of information into a storage region managed by the first app 400. After that, the first app 400 proceeds to S622. If an operation for consent has not been received (an operation for refusal has been received), the first app 400 proceeds to S624. In S624, the first app 400 displays the app home screen 830 of the first app. Then, the first app 400 ends the processing in the flowchart shown in FIGS. 6A and 6B.

In S622, the first app 400 determines whether the consent information has been successfully written into the printing apparatus 102. If it is determined that the consent information has been successfully written, the first app 400 proceeds to S626, and if the consent information has not been successfully written, the first app 400 proceeds to S623. The determination of whether the consent information has been successfully written is made based on information indicative of success or failure of the write, the information being included in the response to a write instruction transmitted from the first app 400 to the printing apparatus 102. In S623, the first app 400 displays the consent information write error screen 1090. The first app 400 then ends the processing in the flowchart shown in FIGS. 6A and 6B.

In S625, the first app 400 writes the consent information into the printing apparatus 102. Although the present embodiment describes an example configuration where the consent information is written based on an instruction from the first app 400 even in a case where consent was received based on an operation performed on the printing apparatus 102 end, the present disclosure is not limited to this. In a case where consent is received based on an operation performed on the printing apparatus 102 end, the writing of the consent information may be done with no intervention of the first app 400.

Once the consent information is written thereinto, the printing apparatus 102 starts communicating with the print management server apparatus 103. Then, the printing apparatus 102 transmits the consent information indicating that consent has been gained and capability information including the serial number to the print management server apparatus 103. After that, the print management server apparatus 103 transmits the consent information indicating that consent has been gained and the capability information including the serial number to the print service server apparatus 120.

In S626, the first app 400 has the browser 430 display the print service introduction screen 970, which is a print service introduction page. In this event, the first app 400 adds the serial number of the printing apparatus 102 to the URL for opening the print service introduction page (the print service introduction screen 970). In other words, the first app 400 executes control for transmitting the serial number from the mobile terminal 101 to the print service introduction server apparatus 130. Also, as will be described later, as a result of the transmission of the serial number by this control, the serial number transmitted by this control is displayed on the print service introduction screen 970 displayed on the mobile terminal 101. Thus, the above control executed by the first app 400 can be said as control for displaying the serial number on the mobile terminal 101. This facilitates the registration of the serial number by the user on the second app 420. The serial number of the printing apparatus 102 used here is the one included in the capability information sent from the printing apparatus 102 to the first app 400 at the time of registration of the printing apparatus 102 with the first app 400. Note that the first app 400 may obtain the serial number from the printing apparatus 102 at the time of writing consent information, and the first app 400 may use the information obtained then.

A detailed description is given of the addition of the serial number. The first app 400 has information on the URL for opening the print service introduction page (the print service introduction screen 970). The first app 400 adds the serial number to this URL as a parameter and has the browser 430 open the print service introduction page. Specifically, the browser 430 transmits a request for the print service introduction page to the print service introduction server apparatus 130. The browser 430 thereby transmits the serial number to the print service introduction server apparatus 130. Based on this request, the print service introduction server apparatus 130 transmits the print service introduction page to the browser 430. In this event, the print service introduction server apparatus 130 also transmits the serial number received as a parameter to the browser 430. In displaying the print service introduction screen 970 based on the print service introduction page received, the browser 430 displays the serial number received from the print service introduction server apparatus 130 on the print service introduction screen 970 as well. The print service introduction screen 970 describes the steps to take to use the print service, and the serial number is displayed on the same screen. Thus, the user can copy the serial number displayed on the browser 430 to the clipboard. After that, in registering the printing apparatus 102 with the second app 420 by following the guide on the print service introduction screen 970, the user can input the serial number not by manually entering the serial number, but by pasting the serial number displayed on the browser 430. Thus, it is easier for the user to register the serial number on the second app 420. In this way, in the present embodiment, the first app 400 performs processing for transmitting the serial number of the printing apparatus 102 to the print service introduction server apparatus 130, which is an external server. As described earlier, the serial number is information that cannot be transmitted unless the mobile terminal 101 too has been brought to consented status by the user giving consent to transmission of information. Thus, also as processing performed prior to transmitting the serial number to the print service introduction server apparatus 130, after the setup, the first app 400 is configured not to perform the processing for displaying the print service introduction page immediately, but to perform the processing for gaining consent. In other words, the first app 400 is configured to perform S620, S621, and the like as the processing for gaining consent. After the processing in S626, the first app 400 ends the processing in the flowchart shown in FIGS. 6A and 6B. After that, as processing performed on the second app 420 end, the second app 420 transmits the serial number to the print service server apparatus 120, and if the serial number is verified, receives the capability information on the printing apparatus 102 from the print service server apparatus 120. Then, printing with the printing apparatus 102 can be performed using the mini app for printing within the second app 420. Although the serial number is displayed on the screen displayed by the browser 430 in the mode described above, the present disclosure is not limited to this mode. The serial number may be displayed on a screen not displayed by the browser, such as a screen displayed by the first app 400. In such a mode, control for transmitting the serial number to the print service introduction server apparatus 130 does not have to be executed. Specifically, for example, the request for the print service introduction page may be transmitted without the serial number of the printing apparatus 102 being added to the URL for opening the print service introduction page, so that the print service introduction page displayed as a result may include no serial number.

Next, a description is given of the processing performed in a case where the printing apparatus 102 is not for the particular country. In S611, the first app 400 determines whether the printing apparatus 102 is in consented status having consent about transmission of information. Specifically, first, the first app 400 communicates with the printing apparatus 102 and obtains information indicating whether the printing apparatus 102 is in consented status from the printing apparatus 102. Then, based on the information thus obtained, the first app 400 makes the determination of this step. Information indicating that the printing apparatus 102 is in consented status is obtained in a case where, for example, an operation for giving consent to transmission of information has been performed on the printing apparatus 102 itself or a case where the first app 400 has previously transmitted consent information. If it is determined that the printing apparatus 102 is in consented status, the first app 400 proceeds to S617, and if it is determined that the printing apparatus 102 is not in consented status, the first app 400 proceeds to S612. Note that if it is determined that the printing apparatus 102 is in consented status, the first app 400 may communicate with the printing apparatus 102 to, e.g., write the consent information, and have the printing apparatus 102 start processing for transmitting information necessary for using the service to an external server.

In S612, the first app 400 displays the information transmission consent reception screen 950 and receives an operation for giving consent or refusal from the user. Next in S613, the first app 400 determines whether an operation for giving consent has been received on the consent reception screen 950. If an operation for giving consent has been received, the first app 400 writes consent information into the printing apparatus 102. Writing consent information into the printing apparatus 102 can be rephrased as transmitting consent information to the printing apparatus 102. If consent information is successfully written into the printing apparatus 102, the printing apparatus 102 is brought into consented status having consent to transmission of information and can now transmit information necessary for using the service to an external server. Also, upon receipt of an operation for giving consent, the first app 400 stores information indicating that the printing apparatus 102 is in consented status having consent about transmission of information into a storage region managed by the first app 400. This brings the mobile terminal 101 into consented status as well, and the mobile terminal 101 can now transmit information necessary for using the service to an external server. After that, the first app 400 proceeds to S614. If an operation for giving consent is not received (an operation for refusal has been received), the first app 400 proceeds to S616. In S616, the first app 400 displays the app home screen 830 of the first app. Then, the first app 400 ends the processing in the flowchart shown in FIGS. 6A and 6B.

In S614, the first app 400 determines whether the consent information has been successfully written into the printing apparatus 102. If it is determined that the consent information has been successfully written, the first app 400 proceeds to S617, and if the consent information has not been successfully written, the first app 400 proceeds to S615. An example case where the consent information is not successfully written is a case where communication error has occurred. In S615, the first app 400 displays the error screen 1090 indicating failed communications with the printing apparatus 102. The first app 400 then ends the processing in the flowchart shown in FIGS. 6A and 6B.

In S617, using the print service server information for the corresponding region stored in the first app 400, the first app 400 obtains the URL for the print service introduction page to be displayed, and has the browser 430 display the print service introduction page. The first app 400 then ends the processing in the flowchart shown in FIGS. 6A and 6B.

In this way, even in a case where the shipping destination of the printing apparatus 102 is not the particular country, the first app 400 performs the processing for gaining consent and writes information indicating that consent has been gained into the printing apparatus 102, as the first app 400 does in a case where the shipping destination of the printing apparatus 102 is the particular country. Also, after the processing for gaining consent, the first app 400 performs the processing for having the browser 430 display a webpage corresponding to the shipping destination of the printing apparatus 102, as the first app 400 does in a case where the shipping destination of the printing apparatus 102 is the particular country. However, in a case where the shipping destination of the printing apparatus 102 is not the particular country, the first app 400 does not perform the processing for adding the serial number to the URL for the webpage. Thus, in a case where the shipping destination of the printing apparatus 102 is not the particular country, the serial number of the printing apparatus 102 is not displayed on the print service introduction page.

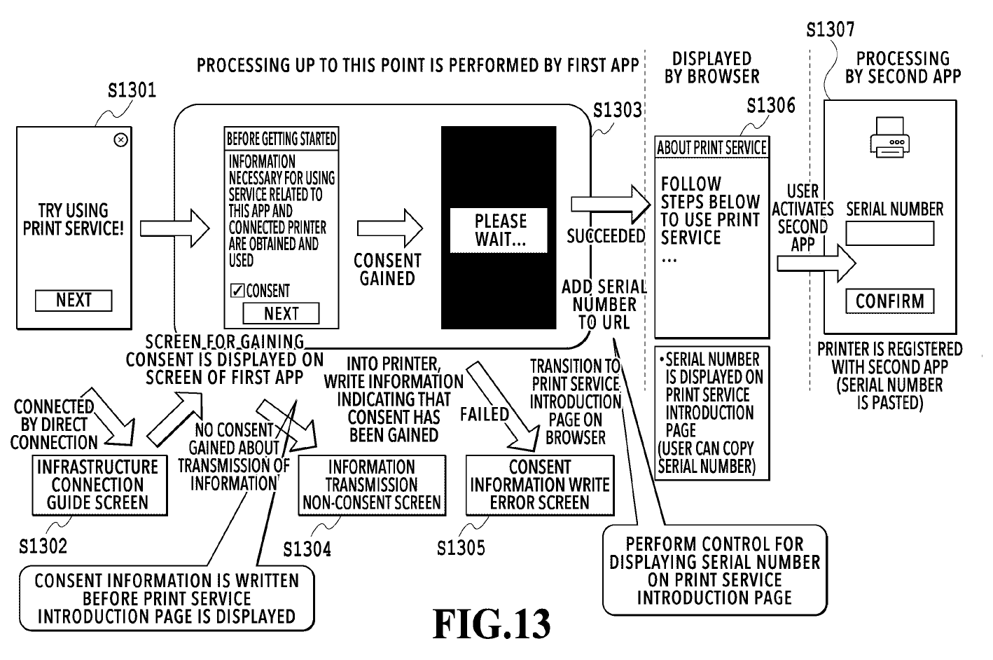

FIG. 13 is a diagram illustrating an overview of the present embodiment. FIG. 13 is a diagram corresponding to the comparative example shown in FIG. 12. S1301 shows the same status as S1202 described with FIG. 12. After that, as shown in S1302, if the printing apparatus 102 is not connected by infrastructure connection, the first app 400 transitions to an infrastructure connection guide screen. If the printing apparatus 102 is connected by infrastructure connection, the first app 400 does not have the browser 430 display the print service introduction page, but performs the processing for gaining consent to transmission of information, as shown in S1303. If there is no consent to transmission of information, the first app 400 displays an information transmission non-consent screen, as shown in S1304. Also, if the first app 400 fails in writing the consent information into the printing apparatus 102, the first app 400 displays a consent information write error screen, as shown in S1305.

If the consent information is successfully written into the printing apparatus 102, as shown in S1306, the first app 400 adds the serial number to the URL for the print service introduction page and has the browser 430 display the print service introduction page. The user can copy the serial number displayed on the print service introduction page. S1307 performed after that is the same as the processing in S1205 described using FIG. 12. The difference is that at the time of registration of the printing apparatus 102 in S1307, the user can paste the copied serial number.

As thus described, the present embodiment can improve the convenience in using a predetermined service through an application program. To be more specific, according to the present embodiment, the first app 400 checks the information transmission consent status and then performs control for displaying the print service introduction page. This avoids going back and forth between the apps, i.e., displaying the print service introduction page and returning to the first app 400 to gain consent to transmission of information. Thus, the present embodiment can improve operability. Further, according to the present embodiment, in having the browser 430 to display the print service introduction page, the first app 400 adds the serial number of the printing apparatus 102 to the URL so that the serial number will also be displayed. As a result, in the event where the browser 430 displays the print service introduction page, the serial number is also displayed. By copying the serial number displayed by the browser 430, the user can later paste the serial number onto the second app 420 that the user uses after that. Thus, the user can easily input the serial number without having to manually input the serial number character by character.

Processing performed in a case where the printing apparatus 102 is the first model has been described above. The following describes processing performed in a case where the printing apparatus 102 is not the first model, or specifically, in a case where the printing apparatus 102 is the second or third model. This processing corresponds to detailed processing in S610 in FIG. 6B.

As described earlier, the second model is a model incapable of notifying the first app 400 of the information indicating whether the printing apparatus 102 is in consented status. With the first model, the first app 400 can determine whether consent has been gained by communicating with the printing apparatus 102. Thus, the first app 400 does not display the consent reception screen 950 in a case where consent has been gained through an operation performed on the printing apparatus 102 end and displays the consent reception screen 950 in a case where consent has not been gained. By contrast, with the second model, the first app 400 cannot determine whether consent has been gained by communicating with the printing apparatus 102. Thus, with the second model, the first app 400 is configured to always display a consent reception screen using a remote UI even in a case where consent has been gained through an operation performed on the printing apparatus 102 end. The following describes the remote UI screen.

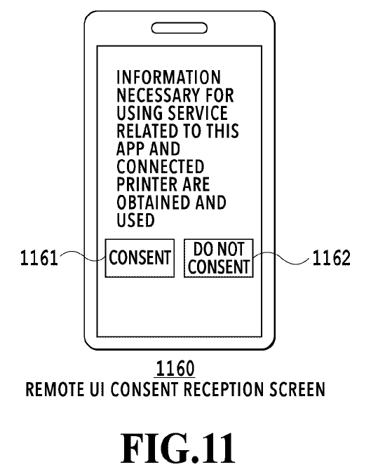

FIG. 11 is a diagram showing an example of a screen displayed on the mobile terminal 101. The processing performed from activating the mobile terminal 101 to displaying the print service guide screen 940 is the same between the second model and the first model. With the second model, after displaying the print service guide screen 940, the first app 400 has the browser 430 display a remote UI consent receiving screen 1160 of the printing apparatus 102. Note that a password input screen for remote UI authentication may be displayed before the remote UI consent receiving screen 1160 is displayed.

The remote UI consent receiving screen 1160 is a screen provided by the printing apparatus 102. In other words, the remote UI consent receiving screen 1160 is a screen where, with the printing apparatus 102 acting as a server, the browser 430 on the mobile terminal 101 is displaying a webpage (the remote UI consent receiving screen 1160) provided by the printing apparatus 102. Upon receipt of pressing of a Consent button 1161 on the remote UI consent receiving screen 1160, the browser 430 on the mobile terminal accesses the URL for the print service introduction page and displays the print service introduction page. In a case where the printing apparatus 102 is the second model, the first app 400 cannot check the information transmission consent status of the printing apparatus 102. Thus, the first app 400 cannot add the serial number to the URL either, as it does in the first embodiment. Thus, the serial number of the printing apparatus 102 is not displayed on the print service introduction page displayed by the browser 430 in the case of the second model. Once a Do Not Consent button 1162 is pressed on the remote UI consent receiving screen 1160, the screen transitions to a different UI remote screen (not shown).

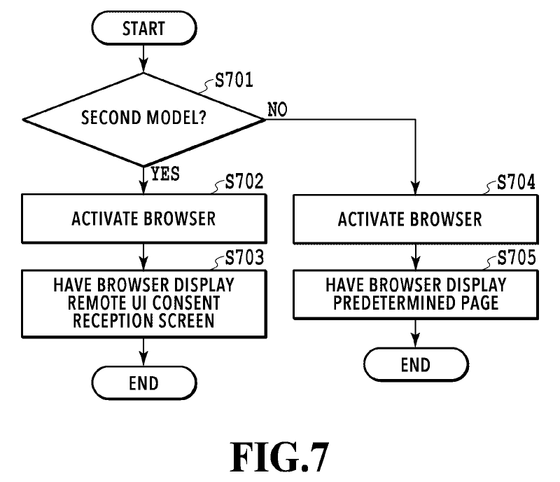

FIG. 7 is a diagram showing a flowchart showing an example of processing performed by the mobile terminal. FIG. 7 is a flowchart showing details of S610 described in the first embodiment. The following describes the processing with reference to FIG. 7.

In S701, the first app 400 determines whether the printing apparatus 102 is the second model. As described earlier, the second model is a model incapable of notifying the first app 400 of information indicating whether the printing apparatus 102 is in consented status. Also, as described earlier, the first app 400 can determine whether the printing apparatus 102 is the second model based on the model name of the printing apparatus 102. If it is determined that the printing apparatus 102 is the second model, the first app 400 proceeds to S702, and if it is determined that the printing apparatus 102 is not the second model, i.e., is the third model, the first app 400 proceeds to S704. The third model is, as described earlier, a model not supporting the cloud printing service. In S704, the first app 400 activates the browser 430. Next in S705, the first app 400 has the browser 430 display a predetermined page. The first app 400 then ends the processing in the flowchart shown in FIG. 7. The predetermined page may be the print service introduction screen 970 described above. A list of models supporting the cloud print service may be displayed on the print service introduction screen 970. In this case, through the print service introduction screen 970, the user can know that the model of the printing apparatus 102 that they have does not support the cloud print service.

In S702, the first app 400 activates the browser 430. Next in S703, the first app 400 has the browser 430 display the remote UI consent receiving screen 1160. The first app 400 then ends the processing in the flowchart shown in FIG. 7. The following describes the processing performed by the browser 430 after that. Upon receipt of pressing of the Consent button 1161 on the remote UI consent receiving screen 1160, the browser 430 transmits information indicating the operation performed on the remote UI consent receiving screen 1160 to the printing apparatus 102. As a result, the printing apparatus 102 identifies that the user has performed an operation to give consent, goes into consent status having consent about transmission of information, and can thereafter transmit information necessary for using the service to an external server. The browser 430 on the mobile terminal then accesses the URL for the print service introduction page and displays the print service introduction page. Note that the remote UI displayed by the browser 430 does not have a function for receiving the serial number. Thus, the addition of the serial number to the URL for the print service introduction page to be accessed by the browser 430, as described in the first embodiment, is not performed, and the serial number is not displayed on the print service introduction page displayed here. Thus, in a case where the printing apparatus 102 is the second or third model, control for displaying the serial number is not executed, such as control for transmitting the serial number from the mobile terminal 101 to the print service introduction server apparatus 130.

As described above, even in a case where the printing apparatus 102 is the second model, after receiving consent through the remote UI using the browser 430, the print service introduction screen 970 is displayed. This avoids going back and forth between the apps, i.e., displaying the print service introduction screen 970 on the browser 430, returning to the first app 400, and then using the browser to gain consent from the user through a remote UI using the browser 430. Thus, even with the second model, the user operability can be improved.

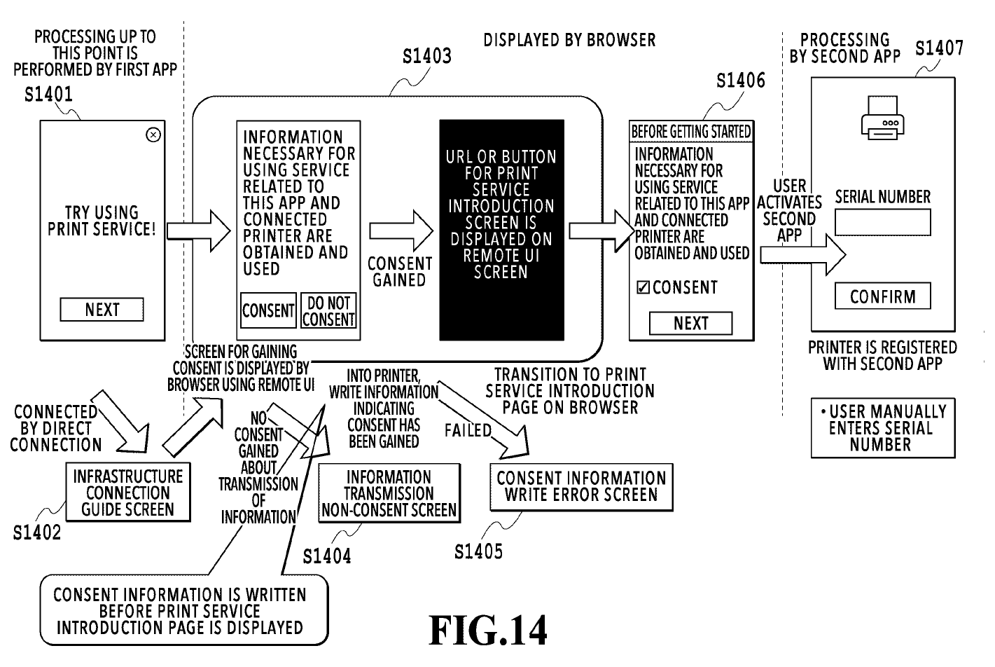

FIG. 14 is a diagram illustrating an overview of the processing described above. FIG. 14 is a diagram corresponding to the comparative example shown in FIG. 12. S1401 shows the same status as S1202 described with FIG. 12. After that, as shown in S1402, if the printing apparatus 102 is not connected by infrastructure connection, the first app 400 transitions to an infrastructure connection guide screen. If the printing apparatus 102 is connected by infrastructure connection, the first app 400 does not have the browser 430 display the print service introduction page, but performs the processing for gaining consent to transmission of information, as shown in S1403. S1403 is processing performed by the browser 430. If the user does not give consent to transmission of information, an information transmission non-consent screen is displayed as shown in S1404. Also, if writing of consent information into the printing apparatus 102 fails, a consent information writing error screen is displayed as shown in S1405. The screens in S1404 and S1405 are remote UI screens displayed by the browser 430.

If writing of consent information into the printing apparatus 102 succeeds, the browser 430 displays the print service introduction page as shown in S1406. S1407 performed next is the same process as S1205 described using FIG. 12. With the second model, the serial number is not displayed on the print service introduction page, and thus, the user cannot copy the serial number.

### Other Embodiments

In the example described in the above embodiment, the print service guide screen 940 is displayed after the mobile terminal 101 installed with the first app 400 executes connection setup process with the printing apparatus 102 and before the app home screen 830 is displayed. Then in the example described, the print service introduction screen 970 is displayed after each process described in the above embodiment is performed. However, the timing at which the first app 400 has the browser 430 display the print service introduction screen 970 is not limited to the example described above. A Cloud button 832 for performing cloud printing is displayed on the app home screen 830. Processing for displaying the print service introduction screen 970 is executed also in the event where the Cloud button 832 on the app home screen 830 is pressed. Specifically, as described earlier, in a case where consent is not gained, processing for having the browser 430 display the print service introduction screen 970 is executed after the consent reception screen 950 is displayed. In this way, the timing of the processing for having the browser 430 display the print service introduction screen 970 after the consent reception screen 950 is displayed is not limited to after the connection setup process. In other words, the first app 400 may execute the processing in the flowchart shown in FIGS. 6A and 6B upon receipt of pressing of the Cloud button 832.

In the example described in the above embodiment, the print service introduction screen 970 is not displayed in a case where no consent is gained on the consent reception screen 950. However, the print service introduction screen 970 may be displayed even in a case where no consent is gained on the consent reception screen 950. However, the serial number is not displayed on the print service introduction screen 970 displayed in a case where no consent is gained.

In the example described in the above embodiment, the serial number is added to the URL for displaying the print service introduction screen 970 in a case where the printing apparatus 102 is the first model and is in consented status. The URL for displaying the print service introduction screen 970 may include information other than the serial number, such as information indicating whether consent has been gained. Then, in a case where information indicating that consent has been gained is not included, the print service introduction screen 970 that the print service introduction server apparatus 130 sends to the browser 430 may include a field showing an operation for giving consent. As described earlier, an operation for giving consent can be executed on both the first app 400 and the printing apparatus 102 itself. Thus, the field showing the operation for giving consent displayed by the browser 430 may include a field corresponding to an operation to perform on the first app 400 and a field corresponding to an operation to perform on the printing apparatus 102 itself. By contrast, in a case where the URL includes information indicating whether consent has been gained, the print service introduction screen 970 that the print service introduction server apparatus 130 sends to the browser 430 does not have to include the field showing an operation for giving consent.

In the example described in the above embodiment, the second app 420 is an SNS app. However, the second app 420 is not limited to an SNS app and may be any app as long as it is an app within which a mini app for printing can be provided.

In the above embodiment, a determination as to whether to execute control to display the consent reception screen 950 by proceeding to S612 (first control) or to execute control not to display the consent reception screen 950 by proceeding not to S612 but to S617 (second control) is made based on information received from the printing apparatus 102, like in S611. Similarly, a determination as to whether to execute control to display the consent reception screen 950 by proceeding to S620 (first control) or to execute control not to display the consent reception screen 950 by proceeding not to S620 but to S625 (second control) is made based on information received from the printing apparatus 102, like in S619. However, the present disclosure is not limited to this. For example, the determination whether to execute the first control or the second control may be made based on a different factor. For example, in a case where an operation for giving consent has not been received from the user at the time of activation of the first app 400, the first app 400 may display the consent reception screen 950 before displaying the home screen. Note that the control to display the consent reception screen 950 before displaying the home screen based on activation of the first app 400 is executed without obtaining information indicating whether the printing apparatus 102 is in consented status from the printing apparatus 102. In other words, this control is executed irrespective of whether the printing apparatus 102 is in consented status. Then, the first app 400 stores information indicating whether an operation for giving consent or an operation for refusal has been received on the consent reception screen 950 displayed before the home screen is displayed. Then, if the determination result of S611 or S619 is YES, the first app 400 determines whether an operation for giving consent has been received (or if an operation for refusal has been received) on the consent reception screen 950 displayed before the home screen is displayed. Then, the first app 400 may proceed to S612 or S620 if the result of this determination is NO, and proceed not to S612 or S620 but to S617 or S625 if the result of this determination is YES. In other words, the first app 400 may perform control based not only on the information indicating whether the printing apparatus 102 is in consented status obtained from the printing apparatus 102, but also on the operation performed on the consent reception screen 950 displayed before the home screen is displayed. Thus, whether to execute the first control or the second control may be controlled based on the operation performed on the consent reception screen 950 displayed before the home screen is displayed.

Also, in a case where there is any update to the scope of consent to be gained from the user, the consent reception screen 950 may be updated at the time of, e.g., an update of the first app 400. In other words, there may be a version for the scope of consent to be gained from the user through the consent reception screen 950. Then, the first app 400 may obtain not only the information indicating whether the printing apparatus 102 is in consented status, but also information indicating the version of the scope of consent that the user gave by operating the printing apparatus 102. Then, in a case where the version indicated by the information is not the latest version, the first app 400 may execute the first control irrespective of whether the printing apparatus 102 is in consented status. In other words, the first app 400 may be configured to execute the second control in a case where the printing apparatus 102 is in consented status and the version of the scope of consent that the user gave by operating the printing apparatus 102 is the latest version.

The present invention can be implemented also by the following processing: a program for implementing one or more of the functions in the embodiment described above is supplied to a system or apparatus through a network or a storage medium, and one or more processors in a computer in the system or apparatus reads and executes the program. The present invention can also be implemented by a circuit (e.g., an ASIC) implementing the one or more functions.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

The present disclosure can improve the convenience in using a predetermined service through an application program.

This application claims the benefit of Japanese Patent Application No. 2025-005469, filed January 15, 2025, which is hereby incorporated by reference herein in its entirety.

What is claimed is:

1. A method for controlling an information processing apparatus executing a first application program, the method comprising:
executing first processing which is processing for gaining, from a user, consent to transmission of predetermined information for using a predetermined service;
on a basis that the consent to transmission of the predetermined information is gained from the user as a result of the execution of the first processing, transmitting, to a communication apparatus, information indicating that the consent to transmission of the predetermined information has been gained from the user;
obtaining the predetermined information from the communication apparatus; and
after the consent to transmission of the predetermined information is gained from the user as a result of the execution of the first processing, executing second processing which is processing for displaying the predetermined information, wherein
on a basis that the information indicating that the consent to transmission of the predetermined information has been gained from the user is transmitted to the communication apparatus, the predetermined information and information on the communication apparatus are transmitted to a server external to the communication apparatus, and
by receiving input of the predetermined information, a second application program obtains the information on the communication apparatus from a server external to the information processing apparatus, the second application program being an application program different from the first application program and an application program for using the predetermined service.

2. The method for controlling an information processing apparatus according to claim 1, wherein
the second processing is processing where information for displaying a predetermined webpage including a field displaying the predetermined information is obtained from a server that provides information for displaying the webpage, by transmitting the predetermined information to the server.

3. The method for controlling an information processing apparatus according to claim 2, further comprising transmitting, to the server that provides information, the information indicating that the consent to transmission of the predetermined information has or has not been gained from the user, wherein
in a case where the consent to transmission of the predetermined information is gained from the user, the webpage does not include a field for gaining the consent to transmission of the predetermined information from the user, and
in a case where the consent to transmission of the predetermined information is not gained from the user, the webpage includes a field for gaining the consent to transmission of the predetermined information from the user.

4. The method for controlling an information processing apparatus according to claim 2, wherein
the predetermined webpage is displayed by a browser function that the first application program has.

5. The method for controlling an information processing apparatus according to claim 2, wherein
the predetermined webpage is displayed by a browser application program different from the first application program.

6. The method for controlling an information processing apparatus according to claim 2, wherein
the predetermined webpage includes a field displaying information indicating how to use the predetermined service.

7. The method for controlling an information processing apparatus according to claim 1, further comprising executing a connection setup process for the communication apparatus, wherein
the first processing is executed after the connection setup process is executed.

8. The method for controlling an information processing apparatus according to claim 7, wherein
the connection setup process includes processing for establishing connection between the communication apparatus and the information processing apparatus via an external access point in a case where the communication apparatus and the information processing apparatus are connected not via the external access point.

9. The method for controlling an information processing apparatus according to claim 1, wherein
the server external to the communication apparatus to which the predetermined information and the information on the communication apparatus are transmitted is different from the server external to the information processing apparatus that provides the information on the communication apparatus to the second application program.

10. The method for controlling an information processing apparatus according to claim 1, wherein
the first processing is processing where a screen for gaining the consent to transmission of the predetermined information from the user is displayed by the first application program or processing where a screen for gaining the consent to transmission of the predetermined information from the user is displayed using a browser function.

11. The method for controlling an information processing apparatus according to claim 10, wherein
the screen for gaining the consent to transmission of the predetermined information from the user displayed using the browser function is displayed based on information provided from the communication apparatus.

12. The method for controlling an information processing apparatus according to claim 1, wherein
based on information obtained from the communication apparatus, control is performed as to which processing to execute as the first processing: processing to display a screen for gaining the consent to transmission of the predetermined information from the user using a browser function or processing to display a screen for gaining the consent to transmission of the predetermined information from the user without using a browser function.

13. The method for controlling an information processing apparatus according to claim 1, wherein
control of whether to execute the first processing and control of whether to execute the second processing are performed based on information obtained from the communication apparatus.

14. The method for controlling an information processing apparatus according to claim 1, wherein
in a case where control is performed not to execute the second processing, information for displaying a predetermined webpage not including a field displaying the predetermined information is obtained from a server and displayed by a browser.

15. The method for controlling an information processing apparatus according to claim 1, wherein
information corresponding to a shipping destination of the communication apparatus registered in the first application program is obtained,
in a case where the shipping destination of the communication apparatus is a first shipping destination, the second processing is executed, and
in a case where the shipping destination of the communication apparatus is a shipping destination other than the first shipping destination, the second processing is not executed.

16. The method for controlling an information processing apparatus according to claim 15, wherein
in a case where the shipping destination of the communication apparatus is a shipping destination other than the first shipping destination, processing for displaying a webpage corresponding to the shipping destination other than the first shipping destination is executed.

17. The method for controlling an information processing apparatus according to claim 1, wherein
it is also possible for the user to give the consent by operating the communication apparatus itself,
the first application program receives, from the communication apparatus, information indicating whether the consent has been obtained, and
based on the information indicating whether the consent has been obtained, a switch is made whether to execute the first processing.

18. The method for controlling an information processing apparatus according to claim 1, wherein
depending on a model of the communication apparatus registered with the first application program, a switch is made between
executing processing to switch whether to execute the first processing based on information indicating whether the consent has been obtained received by the first application program from the communication apparatus, and
executing the first processing irrespective of whether the consent has been obtained, without receiving the information indicating whether the consent has been obtained.

19. An information processing apparatus executing a first application program, the information processing apparatus comprising:
a first execution unit configured to execute first processing which is processing for gaining, from a user, consent to transmission of predetermined information for using a predetermined service;
a transmission unit configured to, on a basis that the consent to transmission of the predetermined information is gained from the user as a result of the execution of the first processing, transmit, to a communication apparatus, information indicating that the consent to transmission of the predetermined information has been gained;
an obtainment unit configured to obtain the predetermined information from the communication apparatus; and
a second execution unit configured to, after the consent to transmission of the predetermined information is gained from the user as a result of the execution of the first processing, execute second processing which is processing for displaying the predetermined information, wherein
on a basis that the information indicating that the consent to transmission of the predetermined information has been gained from the user is transmitted to the communication apparatus, the predetermined information and information on the communication apparatus are transmitted to a server external to the communication apparatus, and
by receiving input of the predetermined information, a second application program obtains the information on the communication apparatus from a server external to the information processing apparatus, the second application program being an application program different from the first application program and an application program for using the predetermined service.

20. A non-transitory computer readable storage medium storing a program which causes a computer to execute a method for controlling an information processing apparatus executing a first application program, the method comprising:
executing first processing which is processing for gaining, from a user, consent to transmission of predetermined information for using a predetermined service;
on a basis that the consent to transmission of the predetermined information is gained from the user as a result of the execution of the first processing, transmitting information indicating that the consent to transmission of the predetermined information has been gained to a communication apparatus;
obtaining the predetermined information from the communication apparatus; and
after the consent to transmission of the predetermined information is gained from the user as a result of the execution of the first processing, executing second processing which is processing for displaying the predetermined information, wherein
on a basis that the information indicating that the consent to transmission of the predetermined information has been gained from the user is transmitted to the communication apparatus, the predetermined information and information on the communication apparatus are transmitted to a server external to the communication apparatus, and
by receiving input of the predetermined information, a second application program obtains the information on the communication apparatus from a server external to the information processing apparatus, the second application program being an application program different from the first application program and an application program for using the predetermined service.
